(19) United States
(12) Patent Application Publication
(10) Pub. No.: US 2026/0196041 A1
(43) Pub. Date: Jul. 9, 2026

(54) VIDEO ANOMALY DETECTION BASED ON OBJECT INTERACTIONS

(71) Applicant: Mitsubishi Electric Research Laboratories, Inc., Cambridge, MA (US)

(72) Inventors: Michael Jones, Belmont, MA (US); Anoop Cherian, Acton, MA (US); Furkan Mumcu, Tampa, FL (US); Yasin Yilmaz, Tampa, FL (US)

(73) Assignee: Mitsubishi Electric Research Laboratories, Inc., Cambridge, MA (US)

(21) Appl. No.: 19/011,731

(22) Filed: Jan. 7, 2025

(51) Int. Cl. G06V 20/40; G06T 7/215; G06T 7/246; G06V 10/62; G06V 10/77; G06V 10/82; G06V 20/70

(52) U.S. Cl. CPC G06V 20/41; G06T 7/215; G06T 7/246; G06V 10/62; G06V 10/7715; G06V 10/82; G06V 20/46; G06V 20/70; G06T 2207/10016; G06T 2207/20081; G06T 2207/20084; G06T 2207/30241

(57) ABSTRACT

Embodiments disclose video anomaly detection for an input video of a scene. An object in the input video is tracked by detecting bounding boxes of the object in a set of frames of the input video. Combined features of the object are extracted from the detected bounding boxes and context features are extracted from the set of frames of the input video in proximity of the detected bounding boxes of the object. An input feature vector for the object is generated by combining the combined features with the context features. A smallest distance from the input feature vector to its closest exemplar is determined based on comparison of the input feature vector with each exemplar in a set of exemplars. An anomaly detection result is produced using the smallest distance to indicate a presence or absence of an anomaly in the scene.

### TECHNICAL FIELD

This disclosure relates generally to computer vision and more particularly to detecting anomalous activity in video.

### BACKGROUND

Closed-circuit television (CCTV) is widely used for security, transport, and other purposes. Example applications include observing crime or vandalism in public open spaces or buildings (such as hospitals and schools), intrusion into prohibited areas, monitoring the free flow of road traffic, detection of traffic incidents and queues, and detection of vehicles traveling the wrong way on one-way roads.

The monitoring of CCTV displays (by human operators) is a very laborious task, and there is considerable risk that events of interest may go unnoticed. This is especially true when operators are required to monitor several CCTV camera outputs simultaneously. As a result, in many CCTV installations, video data is recorded and only inspected in detail if an event is known to have taken place. Even in these cases, the volume of recorded data may be large, and the manual inspection of the data may be laborious. Consequently, it would be advantageous to use automatic devices to process video images to detect when there is an event of interest. Such detection is referred to herein as video anomaly detection and can be used to draw the event to the immediate attention of an operator, to place an index mark in recorded video, and/or to trigger selective recording of CCTV data.

The problem of video anomaly detection is to automatically detect activity in part of a video that is different from activities seen in normal (training) video of the same scene. For example, the video may be of a street scene with people walking along a sidewalk. Anomalous activity to be detected might be people fighting or climbing over a fence, a car driving on the sidewalk, and the like.

Some methods of video anomaly detection use a convolutional neural network autoencoder to learn the typical appearances and motions that occur in the training video. The autoencoder learns to reconstruct typical windows of the training video. To detect anomalies, the autoencoder is used to reconstruct the windows of the testing video. Windows with high reconstruction errors are flagged as anomalous. One drawback of this class of methods is that there is no explicit modeling of objects or their interactions. The autoencoder is trained at the level of pixels and does not have a notion of objects or how they normally interact.

Another class of approaches tries to predict future frames in a test video sequence given preceding frames. A deep neural network is trained on normal video of a scene to minimize the reconstruction error of its prediction of future frames. The assumption is that predicting video frames with normal activity will have low reconstruction error, while predicting frames with unusual activity will have high error. These approaches have a limitation that the deep neural network is trained at the level of pixels and does not have a notion of objects or their interactions.

Another class of approaches is based on learning a dictionary of typical, normal feature vectors found in normal training videos and then reconstructing feature vectors computed from test video from the dictionary of feature vectors of the training video. Depending on the features chosen, this class of methods could model objects, but does not have a way to model their interactions.

A fourth class of approaches to video anomaly detection models the probability distribution of features of the video. Here again, there is no explicit model for the interactions among objects.

Accordingly, there is a need for a system and a method for performing video anomaly detection that overcome the problems and challenges associated with previous approaches, as outlined above.

### SUMMARY

Accordingly, some embodiments disclosed herein provide video anomaly detection systems and methods that are configured for detecting anomalies in videos, such as a surveillance video, which are due to unusual interactions among objects. The objects include things such as people, vehicles, animals, road fixtures, room furniture, and the like. For example, an anomalous interaction between two objects includes two people running into each other or a person leaving a package on the ground or two cars swerving around each other, and the like.

Some embodiments are based on recognizing that one approach to detecting anomalies in the video is based on learning to either reconstruct normal frames of video or predict future frames of video. However, reconstruction and frame-prediction approaches have flaws because the models they learn must generalize well enough to reconstruct or predict normal activity that did not exactly occur in the normal training video, they can also reconstruct/predict anomalous patterns. This causes missed anomaly detections. In addition, reconstruction and prediction-based approaches do not have a way of modeling interactions among objects and thus cannot detect anomalous interactions accurately.

Instead of the established reconstruction and prediction-based approaches to video anomaly detection, it is an object of some embodiments to form a model of normal activity by storing a set of feature vectors, called exemplars, which represent all of the normal activity occurring in normal (training) video of a scene. Activity in a video is represented by detecting objects, either moving or static, in all or some frames of video and then computing features of each object that represent the object's appearance and motion, thereby overall forming appearance features for any object. The various appearance and motion component features describing an object can be concatenated or combined in any manner, into a single feature vector for the object. In addition, objects that are close to each other are grouped together and their feature vectors are stored together to indicate an interaction. Thus, feature vectors for single objects that are not near other objects are stored as well as sets of feature vectors for groups of objects that are close to each other and may be interacting with each other.

Exemplars can be selected from the full set of feature vectors or groups of feature vectors representing all objects detected in a normal training video for a scene via a number of different algorithms for clustering. An exemplar is a feature vector or group of feature vectors for nearby objects representing the various appearance and motion component features describing an object or group of objects that was detected in the normal, training video.

Anomalies in a testing input video are detected by first computing the same type of feature vectors describing all objects in the testing video. Next objects that are close together are grouped together. Then for each single testing feature vector and each group of nearby feature vectors, a distance to each of the exemplars with the same number of grouped objects is computed and the nearest exemplar is found. The distance to the nearest exemplar is the anomaly score. A low anomaly score means that the testing feature vector(s) are similar to an exemplar's feature vectors and is therefore normal. A high anomaly score means that the testing feature vector(s) were unlike any normal exemplar and is therefore anomalous.

The choice of feature vector(s) is important. It is an object of some embodiments for each feature vector to represent the appearance of an object in the video, the trajectory of that object, the size of that object, and the location of that object in the image corresponding to a frame or set of frames of the video. To this end, the feature vector includes multiple components. For example, a feature vector includes features indicative of the appearance of an object in the scene, features indicative of the size of the object, features indicative of the location of the object and features indicative of the trajectory of the object tracked in a set of video frames. In one or more embodiments, the features are collectively referred to as the combined features of the object in the scene.

In some implementations, the appearance component of the combined feature vector is an output from an internal layer (typically the penultimate layer) of a deep network trained to recognize objects from an image of an object. The appearance component is indicative of the object class (for example, “person,” “car,” “bike,” etc.). The trajectory component of the combined feature vector is the displacement of the object over a number of consecutive video frames. The trajectory component can be represented as a vector of x-coordinate and y-coordinate displacements indicating how the center of the object moves from frame to frame. The size component is the height and width of a bounding box around the object. The location component of the feature vector is the x and y coordinates of the center of the object in the video frame. Together these components of the feature vector describe both the appearance and the motion of an object.

All of the components of a feature vector can be computed using various methods in computer vision, namely, a multi-class object detector and an object tracker. In some implementations, these methods are realized using deep neural networks that are trained off-line. These neural networks do not need to be retrained on specific normal video for a particular scene. Furthermore, as technology improves and more accurate or more efficient object detectors and object trackers become available, they can be substituted for older methods leading to improvements in video anomaly detection.

After objects are detected in a frame, groups of objects that are near each other need to be found. To judge distance between objects, the relative 3D positions in space need to be estimated. This requires the depth of each object (distance from the camera) to be estimated. There are a number of techniques that can be used to estimate the relative depth of objects in an image. Techniques for estimating the ground plane are well known in the literature and can be used by assuming objects are resting on the ground. Techniques for estimating relative depth from a single image using a neural network are also well known and can be used for this purpose. Given a relative depth estimate for each object along with their 2D positions in the image, a simple Euclidean distance can be computed to determine the distance between two objects. A threshold can then be used to associate two objects that are close together.

Accordingly, different embodiments describe a system of one or more computers that can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by a data processing apparatus, cause the apparatus to perform the actions.

According to an embodiment, a system for video anomaly detection in a scene is provided. The system comprises an input interface configured to accept an input video of the scene, and a memory configured to store a set of exemplars. An exemplar includes features that are extracted from tracked bounding boxes of an object tracked in different frames of a normal video of the scene and combined with features representing a context associated with the object in the normal video of the scene. The features representing the context are extracted from the bounding boxes in proximity of the tracked bounding boxes. The system also includes a processor configured to track an object moving in the input video of the scene by detecting bounding boxes of the object in a set of frames of the input video. The object tracking is used to define a trajectory of the object which constitutes a motion feature for the object. The object detector also provides the size and location of an object which are used to define size and location features. The processor is further configured to extract combined features of the object in the scene from the detected bounding boxes, the combined features indicative of an appearance of the object in the scene, a size of the object in the scene, a location of the object in the scene, and a trajectory of the object within the scene. Additionally, the processor is configured to extract context features from the set of frames of the input video in proximity of the detected bounding boxes. The context features are indicative of context of the object in the scene. The processor is further configured to generate an input feature vector for the object by combining the combined features which include the appearance, the size, the location, and the motion features with the context features and determining a smallest distance from the input feature vector to its closest exemplar. The closest distance is determined based on a comparison of the input feature vector with each exemplar in the set of exemplars. The comparison is used to output an anomaly detection result, based on a comparison of the smallest distance with a threshold. The anomaly detection result is indicative of a presence of an anomaly or an absence of the anomaly, for performing the video anomaly detection in the scene.

According to another embodiment, a system for video anomaly detection in a scene is provided. The system comprises an input interface configured to accept an input video of the scene and a memory configured to store a set of exemplars, each exemplar of the set of exemplars includes features that are extracted from tracked bounding boxes of a first object tracked in different frames of a normal video of the scene and combined with features of a second object tracked in the different frames of the normal video of the scene, such that the second object is in proximity of the tracked bounding boxes of the first object. The system also comprises a processor configured to track the first object moving in the input video of the scene by detecting bounding boxes of the first object in a set of frames of the input video. The tracking and detection also provide size and location features of the first object. The processor is further configured to extract combined features of the first object in the scene from the detected bounding boxes, the combined features indicative of an appearance of the first object in the scene, a size of the first object in the scene, a location of the first object in the scene, and a trajectory of the first object within the scene. The processor is further configured to extract combined features of the second object in the scene, from the set of frames of the input video in proximity of the bounding boxes of the first object, the combined features of the second object indicative of an appearance of the second object in the scene, a size of the second object in the scene, a location of the second object in the scene, and a trajectory of the second object within the scene. The processor is configured to generate an input feature vector by combining the combined features of the first object and the combined features of the second object. Additionally, the processor is configured to determine a smallest distance from the input feature vector to its closest exemplar based on a comparison of the input feature vector with each exemplar in the set of exemplars. The processor is then configured to output an anomaly detection result based on a comparison of the smallest distance with a threshold. The anomaly detection result is indicative of a presence of an anomaly or an absence of an anomaly, for performing the video anomaly detection in the scene.

According to some embodiments, each of the exemplars is separated from its closest exemplar by a minimum distance.

According to various embodiments a feature vector of any exemplar includes features indicative of the appearance of an object in the scene, features indicative of the size of the object, features indicative of the location of the object and features indicative of a trajectory of the object tracked in a set of frames of the normal videos.

According to some embodiments, the system includes the processor that is configured to detect and track all objects from a set of input frames of the input video, and then extract input appearance features indicative of the appearance of the object in the scene frame, input size features indicative of the size of the object in the scene, input location features indicative of the location of the object in the scene, and input trajectory features indicative of a trajectory of the object tracked in a set of frames of the input video of the scene. The input appearance features, the input size features, the input location features, and the input trajectory features are combined to produce an input feature vector.

According to some embodiments, an estimate of a 3D position of each detected object is obtained. Further, objects are grouped together to identify objects that are in close proximity to each other based on a distance.

In various embodiments, the smallest distance from the input group of feature vectors to its closest exemplar is determined and an anomaly is declared when the smallest distance is greater than a threshold.

Other embodiments of this aspect include corresponding computer systems, apparatus, and computer programs recorded on one or more computer storage devices, each configured to perform the actions of various methods described herein.

According to an embodiment, a method for video anomaly detection in a scene is provided. The method includes accepting an input video of the scene and tracking an object moving in the input video of the scene by detecting bounding boxes of the object in a set of frames of the input video. The method further includes extracting combined features of the object in the scene from the detected bounding boxes, the combined features indicative of an appearance of the object in the scene, a size of the object in the scene, a location of the object in the scene, and a trajectory of the object within the scene. The method also includes extracting context features from the set of frames of the input video in proximity of the bounding boxes indicative of context of the object in the scene. The method further includes generating an input feature vector for the object by combining the combined features with the context features and determining a smallest distance from the input feature vector to its closest exemplar based on a comparison of the input feature vector with each exemplar in a set of exemplars. Each exemplar includes features that are extracted from bounding boxes of an object tracked in different frames of a normal video of the scene and combined with features representing a context associated with the object in the normal video of the scene, the features representing the context being extracted from bounding boxes in proximity of the tracked bounding boxes of the object. The method further includes outputting an anomaly detection result based on a comparison of the smallest distance with a threshold. The anomaly detection result is indicative of a presence or an absence of an anomaly in the scene.

According to some embodiments, the method may include grouping input feature vectors belonging to objects that are close together in terms of 3D distance and comparing the groups of input feature vectors with each of the exemplars to determine the smallest distance from the groups of input feature vectors to its closest exemplar.

According to some embodiments, the method may also include declaring the anomaly when the smallest distance is greater than a threshold.

### BRIEF DESCRIPTION OF THE DRAWINGS

FIG. 1 shows a block diagram of a system for video anomaly detection for detecting anomalies in videos coming from a scene, in accordance with some embodiments of the present disclosure.

FIG. 2 illustrates a block diagram of an architecture of the system for performing video anomaly detection, in accordance with an example embodiment of the present disclosure.

FIG. 3 shows a flowchart of a method performed by the system for anomaly detection, according to some embodiments of the present disclosure.

FIG. 4A illustrates a schematic diagram showing a selection algorithm for the set of exemplars from a large set of training feature vector groups, according to an embodiment of the present disclosure.

FIG. 4B illustrates a method implemented by the system for selection of the set of exemplars, according to an embodiment of the present disclosure.

FIG. 5 illustrates a flowchart of a method for determining features suitable for video anomaly detection, according to some embodiments of the present disclosure.

FIG. 6 illustrates a schematic diagram of a neural network, according to some embodiments of the present disclosure.

FIG. 7 illustrates a schematic of a method for detecting objects in an image and tracking objects in one or more images, according to an embodiment of the present disclosure.

FIG. 8 shows a schematic diagram of a method for extracting appearance features from an image patch of an object defined by a bounding box from an input frame, according to some embodiments of the present disclosure.

FIG. 9 shows a flowchart of a method for extracting trajectory features from frames of the input video, according to an embodiment of the present disclosure.

FIG. 10 illustrates a diagram showing exemplary code including data extracted from different frames of the input video, according to an embodiment of the present disclosure.

FIG. 11 illustrates a block diagram of a system for video anomaly detection including multiple objects in the scene, according to an embodiment of the present disclosure.

FIG. 12 illustrates a block diagram of a method for anomaly detection, according to an embodiment of the present disclosure.

FIG. 13 illustrates a schematic of a method used for determining the closest exemplar, according to an embodiment of the present disclosure.

FIG. 14 illustrates a method for transforming the frames of the input video into a graph representation and then performing anomaly detection, according to an embodiment of the present disclosure.

FIG. 15A illustrates a block diagram of a method for transformation of frames of the input video into graph representation data, according to an embodiment of the present disclosure.

FIG. 15B illustrates a block diagram of a method for forming connections between interacting graph nodes, according to an embodiment of the present disclosure.

FIG. 16A shows a schematic diagram of a scene-aware video encoder system, according to some embodiments of the present disclosure.

FIG. 16B shows a representation for segregation of the spatio-temporal scene graph, according to some embodiments of the present disclosure.

FIG. 17 illustrates a block diagram of a computing system for video anomaly detection, in accordance with some embodiments of the present disclosure.

FIG. 18 illustrates a schematic diagram of an application of the system for video anomaly detection, according to an embodiment of the present disclosure.

FIG. 19 illustrates a schematic diagram of another application of the system for video anomaly detection, according to an embodiment of the present disclosure.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various embodiments disclose a system and a method for performing video anomaly detection in real-world scenarios that involve anomalous interactions among people and objects.

The system and the method disclosed in various embodiments provides a technical solution to the problem of video anomaly detection by taking advantage of recent advances in object detection and tracking to first detect and track all objects in each frame of a video and then build an object-centric representation of the objects and attributes (such as object class, size, position and pose). The various embodiments disclose modeling of pairs of objects that are deemed to be interacting. The set of pairs of objects detected in a nominal video that represent all unique pairs of interacting objects found in nominal video are stored in the form of exemplars. Such a model of normal object interactions enables distinguishing normal interactions from anomalous ones found on a testing video.

Some embodiments disclose modeling of pairs of interacting objects to detect anomalies involving unusual interactions between two objects which was not disclosed in prior methods of video anomaly detection. To that end, various embodiments disclosed herein provide a system and a method for detecting anomalies in a video captured from a real-world scene such as from a busy street. The anomalies relate to unusual interactions between objects in the scene, such as between a human and a vehicle on a road, that may cause potential damage or accidents, and which can be prevented by using the system and the method disclosed herein. To that end the system and the method disclosed herein enable detection of such anomalies in real-time and provide an output to users or vehicle navigation systems and the like, in the form of alerts, notifications, visual indicators, and the like, which prevent the occurrence of potential damage and accident situations.

In some embodiments, interactions between objects are modeled in a form of a context involving two objects. The context may be based on different criteria such as distance between objects, poses of objects, placement of objects, appearance of objects, and the like.

The systems and methods disclosed herein may be implemented in any form of computing devices, controllers, image processing systems, communication devices, vehicle navigation assistance systems, and the like.

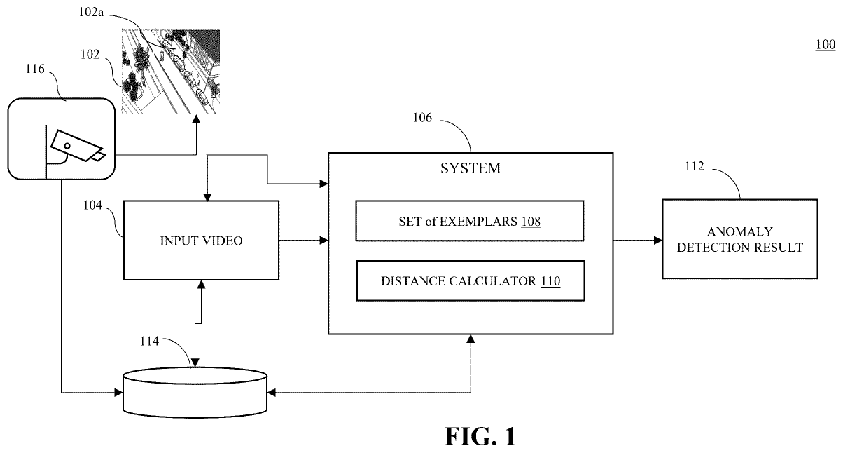

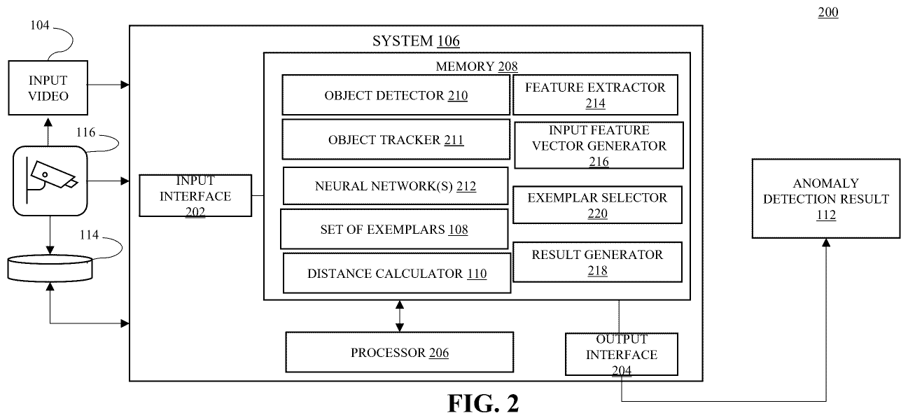

FIG. 1 shows a block diagram 100 of a system 106 for video anomaly detection that is configured for detecting anomalies in videos coming from a scene 102, in accordance with some embodiments. The system 106 may be embodied within an image processing system or may be coupled to an image processing system. The system 106 includes a processor configured to execute stored instructions, as well as a memory that stores instructions that are executable by the processor (these are shown later in conjunction with FIG. 2).

The system 106 receives an input video 104 of the scene 102. The scene 102 may be a real-world environment such as a road, a university campus, a hospital, a house, a factory, a school, a restaurant, and the like. The scene 102 includes different objects such as people and non-living objects like vehicles, furniture, machines, trees, food items and the like. The input video 104 of the scene 102 may be captured using one or more data capturing devices 116 positioned at some positions or locations within the scene 102. The one or more data capturing devices 116 may include cameras, depth sensors, CCTV equipment, surveillance cameras, drone operated video capturing devices, and the like.

In some embodiments, the one or more data capturing devices 116 collect videos at various times during the day and on each day of the week, and these videos may be stored in a database 114 which may be an internal or external storage device, coupled to the system 106. The input video 104 is one such instance of these different videos which is considered for processing by the system 106 at a particular time instance. The input video 104 comprises several frames of video. In an example, each frame has a resolution of 1920 pixels wide by 1080 pixels high.

In an embodiment, the system 106 is configured to process the input video 104 of the scene 102 to track an object 102a moving in the input video 104 of the scene 102 by detecting bounding boxes of the object 102a in a set of frames of the input video 104. Further, the system 106 is configured to extract combined features of the object 102a in the scene 102 from the detected bounding boxes, the combined features indicative of an appearance of the object 102a in the scene 102, a size of the object 102a in the scene 102, a location of the object 102a in the scene 102, and a trajectory of the object 102a within the scene 102. The system 106 is also configured to extract context features from the set of frames of the input video 104 in proximity of the detected bounding boxes of the object 102a, the context features being indicative of context of the object 102a in the scene 102. The system 106 then generates an input feature vector for the object 102a by combining the combined features with the context features. The system 106 then determines a smallest distance from the input feature vector to its closest exemplar based on a comparison of the input feature vector with each exemplar in a set of exemplars 108 that may be stored in the system 106 in an internal storage or may be stored in the database 114 and may be accessed by the system 106 at the time of processing of the input video 104. The smallest distance is determined by a distance calculator 110, which may be a block of code or program instructions stored in a memory of the system 106 and configured for calculating the smallest distance between the input feature vector and each exemplar in the set of exemplars 108. The system 106 is then configured to output an anomaly detection result 112 based on a comparison of the smallest distance with a threshold. The anomaly detection result 112 is indicative of a presence of an anomaly in the scene 102 or an absence of an anomaly in the scene 102, for performing the video anomaly detection in the scene 102 by the system 106.

### System Architecture

FIG. 2 illustrates a block diagram of an architecture 200 of the system 106 for performing video anomaly detection, in accordance with an example embodiment of the present disclosure. FIG. 2 is explained in conjunction with elements of FIG. 1. The system 106 comprises an input interface 202 that is configured to accept the input video 104 of the scene 102. The input interface 202 may include a receiver that is configured to receive the input video 104 from the one or more image capturing devices 116 in an embodiment. In another embodiment, the input video 104 may be received from the database 114, such as by an uploading of the input video 104 from the database 114 to the system 106, via the input interface 202.

The system 106 also includes a memory 208 that is configured to store the set of exemplars 108, such that each exemplar in the set of exemplars 108 includes features that are extracted from tracked bounding boxes of an object tracked in different frames of a normal video of the scene 102 and combined with features representing a context associated with the object in the normal video of the scene 102. The features representing the context are extracted from bounding boxes in proximity of the tracked bounding boxes. The memory 208 may include random access memory (RAM), read only memory (ROM), flash memory, or any other suitable memory systems. The memory 208 may be implemented using a hard drive, an optical drive, a thumb drive, an array of drives, or any combination thereof.

The memory 208 also stores computer-executable instructions in the form of different modules of such computer-executable instructions. Each module is configured to perform a set of operations that are defined by the computer-executable instructions stored in the memory 208 for that particular module. The operations performed by the different modules cause the system 106 to perform video anomaly detection for the scene 102 by outputting the anomaly detection result 112, such as via an output interface 204 of the system 106. The output interface 204 may comprise any display interface, an audio interface, a light indicator, a tactile feedback interface, a video interface, a text interface, or any other output interfacing technology advancement envisioned in the future.

The modules include for example, an object detector 210, an object tracker 211, one or more neural networks 212, a feature extractor 214, an input feature vector generator 216, the distance calculator 110, a result generator 218, and an exemplar selector 220.

In an embodiment, the object detector 210 is configured to detect objects in each frame of the input video 104 and the object tracker 211 is configured to track each detected object by associating bounding boxes in multiple frames of the input video 104 with a particular detected object.

In an embodiment, the feature extractor 214 is configured to extract combined features of the object 102a in the scene 102 from the detected bounding boxes, the combined features indicative of at least, an appearance of the object 102a in the scene 102, a size of the object 102a in the scene 102, a location of the object 102a in the scene 102, and a trajectory of the object 102a within the scene 102. The feature extractor 214 is also configured to extract context features from the set of frames of the input video 104 that are in vicinity of the detected bounding boxes of the object. The context features are indicative of context for presence of the object in the scene 102. The context features may correspond to combined features of a second object in the scene 102. The second object may have the context of being associated with or connected to the object in the scene 102. For example, the second object may be in vicinity of the object 102a, may be connected to the object 102a, may be placed under the object 102a, may be touched by the object 102a, and the like. To that end, the object 102a and the second object may form a pair of connected objects in the scene 102, such that their connection is defined by a context or relationship.

In an embodiment, the context associated with the object 102a in the scene 102 is indicative of an interaction of the object 102a with one or more other objects in the scene 102, such as an interaction of the object 102a with the second object. To that end, the one or more other objects occur in the same frames as the object and are in proximity to or in vicinity of the bounding boxes of the object 102a. The proximity or vicinity are interchangeably used to mean the same throughout the scope of the present disclosure. The proximity or the vicinity is determined on the basis of distance between the object 102a and the second object. The distance may be further compared with a threshold distance value to determine the proximity or the vicinity of the object 102a with the second object. In an example, if the distance is lesser than or equal to the threshold distance value, then the object 102a is determined to be proximal or in vicinity of the second object. In an alternate example, if the distance is greater than the threshold distance value, then the object 102a is determined to be not proximal to or not in vicinity of, or far from the second object.

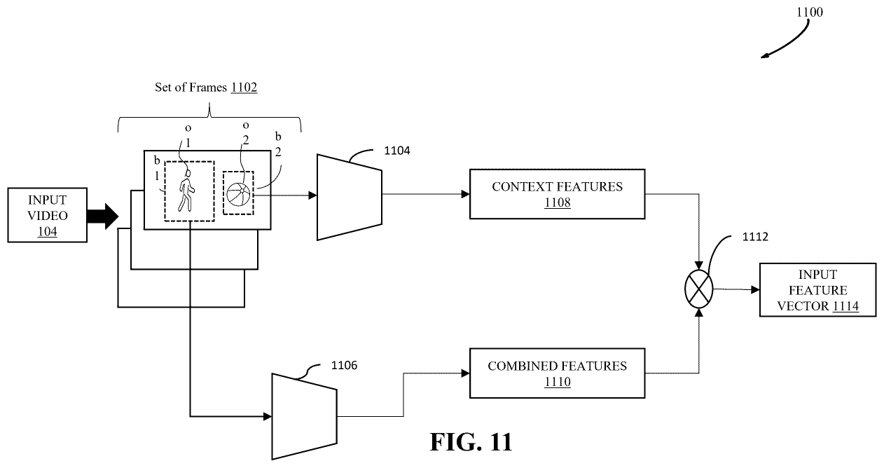

In an embodiment, the scene 102 includes a first object and a second object, and the context features of the first object are the combined features of the second object, such that the object is either of the first object or the second object in the scene 102. This is explained further in conjunction with FIG. 11.

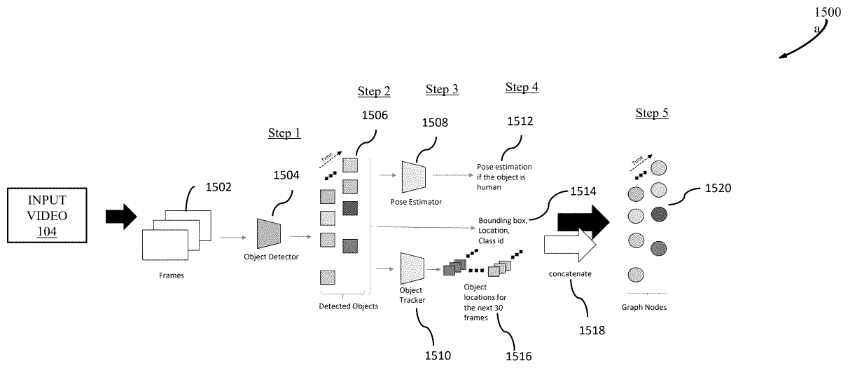

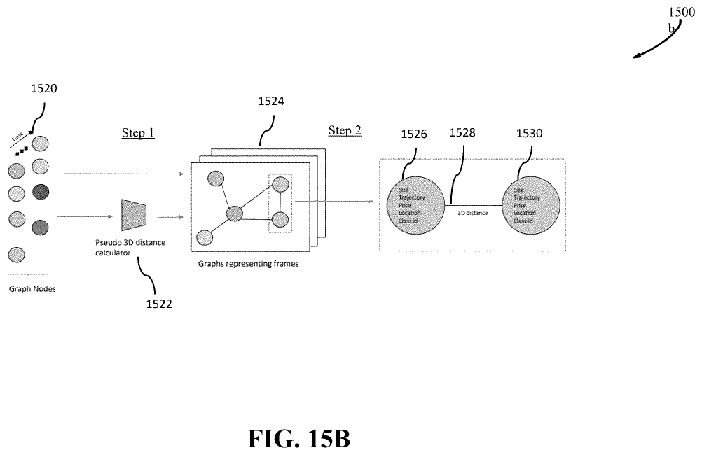

In an embodiment, the input feature vector generator 216 is configured to generate an input feature vector for the object 102a by combining the combined features with the context features. The combination of the combined features and the context features is done when the 3D distance between the object with the combined features and the second object with the context features is below a predefined threshold value. Each feature vector for an object in turn may be a combination of attributes such as a bounding box attribute, a class attribute, a pose attribute, a location attribute, a trajectory attribute, and the like. This is explained further in conjunction with FIG. 11, FIG. 15A, and FIG. 15B.

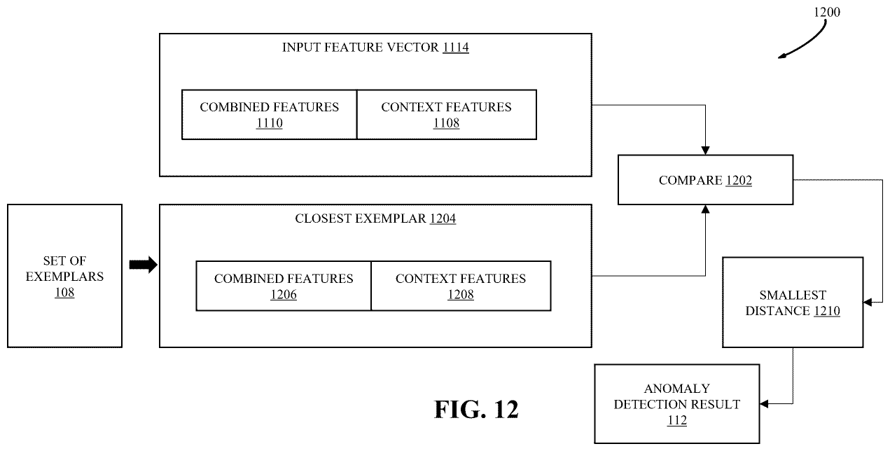

In an embodiment, the distance calculator 110 is configured to determine a smallest distance from the input feature vector to its closest exemplar based on a comparison of the input feature vector with each exemplar in the set of exemplars 108. This is explained further in conjunction with FIG. 12.

In an embodiment, the result generator 218 is configured to generate the anomaly detection result 112, based on a comparison of the smallest distance with a threshold. The anomaly detection result 112 is then outputted via the output interface 204. The anomaly detection result is indicative of a presence of an anomaly or an absence of the anomaly, for performing the video anomaly detection in the scene 102. To that end, the anomaly detection result 112 may include a numerical value indicating the presence or the absence of the anomaly in the scene 102. For example, the anomaly detection result 112 may have a value of one to indicate the presence of the anomaly in the scene 102, and the anomaly detection result 112 may have a value of zero to indicate the absence of the anomaly in the scene 102. In other examples, any range of numerical values may be equivalently used for indicating the presence or the absence of the anomaly in the scene 102, without deviating from the scope of the present disclosure.

The system 106 also includes a processor 206 configured to execute different operations for performing video anomaly detection, some of which were discussed above in conjunction with FIG. 1. To that end, the processor 206 is configured to execute computer-executable instructions that are stored in the memory 208 to execute the operations of different modules stored in the memory 208. The processor 206 can be a single core processor, a multi-core processor, a computing cluster, or any number of other configurations. The processor 206 is connected through a bus to one or more input and output devices.

Some embodiments are based on recognizing that video anomaly detection can be approached by comparing a group of feature vectors of the input video 104 that capture both the appearance and motion information of objects in a training video to the same types of groups of feature vectors computed from the input video 104. However, storing and comparing all possible groups of feature vectors from the training video is not computationally feasible.

It is an object of some embodiments to address this limitation by selecting a set of representative groups of feature vectors from the training video, that is the set of exemplars 108 in the system 106, that cover the set of all possible groups of feature vectors from the training video. To that end, the exemplar selector 220 is used to select the set of exemplars 108. Exemplars can be selected from the full set of training groups of feature vectors using various algorithms such as clustering algorithms or exemplar-selection algorithms. The resulting set of exemplar feature vector groups has the property that there is a minimum distance between any two exemplars. In various embodiments, anomaly detection produces a set of bounding boxes indicating the locations and sizes of any anomalies in each video frame of the input video 104. The system 106 is configured to detect anomalies in the input video 104 by comparing feature vectors computed from input video 104 to exemplar feature vectors, referred to herein as the set of exemplars 108, stored in the memory 208. The set of exemplars 108 are computed from a training video of the same scene 102. Feature vectors include appearance, size, and location components computed using the object detector 210. In an embodiment, a trajectory component may be computed using an object tracker.

In an embodiment, the system 106 is configured to implement an anomaly detector, such as in the form of the result generator 218, that compares groups of feature vectors computed from the input video 104 to groups of feature vectors of the training video of the same scene to declare anomalies when an input feature vector is dissimilar to all exemplar feature vectors from the training video.

The system 106 also includes the one or more neural networks 212 that are configured to perform the operations of the one or more modules described above.

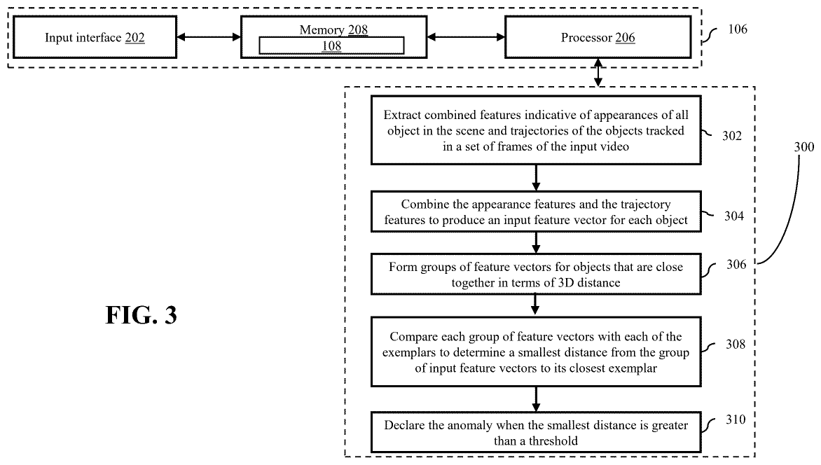

FIG. 3 shows a flowchart of a method 300 performed by the system 106 for performing anomaly detection according to some embodiments. FIG. 3 is explained in conjunction with elements from FIG. 1 and FIG. 2. The system 106 collects the input video 104 of the scene 102 via the input interface 202. Further, the memory 208 of the system 106 stores the set of exemplars 108 that are a group, or a set of feature vectors computed from normal videos of the scene 102. In an embodiment, the set of exemplars 108 are stored during a training period for the system 106. Further, the system 106 includes the processor 206 that is configured to execute the method 300. The method 300 includes various operations, such as from 302 to 310 that cause the processor 206 to execute computer executable instructions and perform various operations of the method 300.

The processor is configured to extract 302 feature vectors including combined features of the object 102a in the scene 102, from the detected bounding boxes tracking the object in the scene 102. The combined features are indicative of an appearance of the object in the scene 102, a size of the object in the scene 102, a location of the object in the scene 102, and a trajectory of the object within the scene 102. In an embodiment, the processor 206 extracts 302 the combined features indicative of appearance of all objects in the scene 102 and trajectory features indicative of trajectories of all objects in the scene 102. The processor 206 is configured to combine 304 the appearance, trajectory, size, and location features to produce an input feature vector for each object. Further, groups of input feature vectors are then formed 306 based on the proximity of the objects in the scene 102. That is, the objects that are proximal to each other on the basis of their 3D distance in the scene 102 are considered as a group of objects, and their corresponding feature vectors form a group of feature vectors for those objects. A particular feature vector may be associated with multiple distinct groups.

In an embodiment, the processor 206 is then configured to compare 308 each group of feature vectors with each exemplar in the set of exemplars 108 to determine the smallest distance to a closest exemplar. An anomaly is declared 310 when the smallest distance exceeds a threshold. In an embodiment, the threshold is selected by a user of the system 106. For example, the user is a human monitoring a CCTV footage from a building, such that the CCTV footage forms the input video 104. The set of exemplars 108 in the memory represent groups of features indicative of the appearance, size, and location of different objects in the scene 102 and the trajectories of corresponding objects tracked in a set of consecutive frames of the normal videos of the scene 102. To that end, the system 106 enables efficient and accurate detection of anomalies in the input video 104, such as a video received from a video surveillance application.

Some embodiments use different methods for detecting and tracking objects within a video sequence to extract the appearance, size, location, and trajectory features for anomaly detection. For example, one method involves object detection, where algorithms are used to identify and localize objects within individual frames of a video. This can be achieved using various image processing techniques which typically involve training on example images of the object classes of interest. Once an object is detected, a bounding box is placed around it to define its location and spatial extent. A feature vector is computed from the image patch inside the bounding box that is representative of the object class appearing within the image patch. This approach only provides information about the object's appearance, location, and size in a single frame and does not consider its temporal behavior.

Another method involves object tracking, which aims to follow the movement of objects across multiple consecutive frames of a video. Various tracking algorithms have been developed, including correlation-based methods, optical flow-based methods, and Kalman filter-based methods. These algorithms use the object's position in previous frames to predict its location in subsequent frames, allowing for the placement of bounding boxes around the object in multiple frames. Such tracking algorithms compute the trajectory of an object over multiple, consecutive frames.

Some embodiments are based on the understanding that both object detection and tracking approaches can be used separately in video anomaly detection, the separate and/or independent utilization of these approaches often fails to provide a comprehensive solution that combines both appearance and trajectory features. The lack of integration between these features limits the accuracy and effectiveness of anomaly detection algorithms. Therefore, some embodiments determine features suitable for video anomaly detection by combining the extraction of appearance features from individual frames and trajectory features from multiple frames.

Some embodiments are further based on the understanding that detecting certain anomalies requires analyzing two or more objects together in order to detect anomalous interactions among the objects. In this context, an object can be a person. Therefore, some embodiments group together objects that are in close proximity and are thus likely to be interacting. Groups of feature vectors corresponding to nearby groups of objects are then compared to exemplars found in normal videos to determine how similar they are to normal groups. In an embodiment, groups of feature vectors correspond to features of the object 102a and features of the context associated with the object 102a. When the context associated with the object 102a is a second object, the object 102a and the second object form the group of objects and their corresponding feature vectors form the group of feature vectors.

Various exemplar selection algorithms may be executed by the exemplar selector 220 to compute a distance between two groups of feature vectors. In some embodiments, a feature vector includes multiple component features for appearance, size, location, and trajectory. Let feature vector f₁=[a₁, s₁, l₁, t₁] where a₁=[a₁₁, a₁₂, . . . , a₁ₙ] is an appearance feature vector of length n, s₁=[w₁, h₁] is the size feature vector representing the width and height of an object bounding box, l₁=[x₁, y₁] is the location feature vector representing the (x,y) image coordinates of the center of an object bounding box and t₁=[dx₁₁, dy₁₁, dx₁₂, dy₁₂ . . . , dx_{1F}, dy_{1F}] is the trajectory feature vector representing the x and y displacements (dx₁ᵢ, dy₁ᵢ) of the center of the object bounding box for F consecutive video frames.

Different embodiments can use several types of distance formulations. For example, in one embodiment, the distance between two feature vectors f₁ and f₂ is computed as the maximum distance over each of the component distances:

$$dist ( {f}_{1} , {f}_{2} ) = max ( \frac{A ( {a}_{1} , {a}_{2} ) - {μ}_{A}}{{σ}_{A}} , \frac{S ( {s}_{1} , {s}_{2} ) - {μ}_{S}}{{σ}_{S}} , \frac{L ( {l}_{1} , {l}_{2} ) - {μ}_{L}}{{σ}_{L}} , \frac{T ( {t}_{1} , {t}_{2} ) - {μ}_{T}}{{σ}_{T}} )$$

where A(a₁, a₂) is an appearance distance, S(s₁, s₂) is a size distance, L(l₁, l₂) is a location distance, and T(t₁, t₂) is a trajectory distance and each of the M and a scalars are normalization constants that make each distance function comparable.

The appearance distance is the Euclidean distance between appearance feature vectors,

$$A ( {a}_{1} , {a}_{2} ) = \sqrt{{\sum }_{i = 1}^{n} {( {a}_{1 i} - {a}_{2 i} )}^{2}} .$$

The size distance is the Euclidean distance between each object's width and height normalized by the minimum width and height:

$$S ( {s}_{1} , {s}_{2} ) = \sqrt{\frac{{( {w}_{1} - {w}_{2} )}^{2}}{min ( {w}_{1} , {w}_{2} )} + \frac{{( {h}_{1} - {h}_{2} )}^{2}}{min ( {h}_{1} , {h}_{2} )}} .$$

The location distance is the Euclidean distance between the centers of the bounding boxes of the two objects:

$$L ( {l}_{1} , {l}_{2} ) = \sqrt{{( {x}_{11} - {x}_{21} )}^{2} + {( {y}_{11} - {y}_{21} )}^{2}} .$$

The trajectory distance is the sum of the distances between the displacements of the first trajectory and the displacements of the second trajectory divided by the minimum displacements

$$A ( {a}_{1} , {a}_{2} ) = {\sum }_{i = 1}^{n} ( \frac{\vert {dx}_{1 i} - {dx}_{2 i} \vert}{max ( min ( {dx}_{1 i} , {dx}_{2 i} ) , 1 )} + \frac{\vert {dy}_{1 i} - {dy}_{2 i} \vert}{max ( min ( {dy}_{1 i} , {dy}_{2 i} ) , 1 )} ) .$$

Other distance functions could be used instead of the ones given above.

The distance between two groups of feature vectors, F={f₁, f₂, . . . , fₙ} and E={e₁, e₂, . . . , eₙ}, can be defined as

$$dist ( F , E ) = {min}_{{p \vert p is a permutation}_{of [ 1 , 2 , … , n ]}} {\sum }_{i = 1}^{n} dist ( {f}_{p [ i ]} , {e}_{i} )$$

This distance is the minimum sum of feature distances for all possible pairings of feature vectors between sets F and E.

### Exemplar Selection

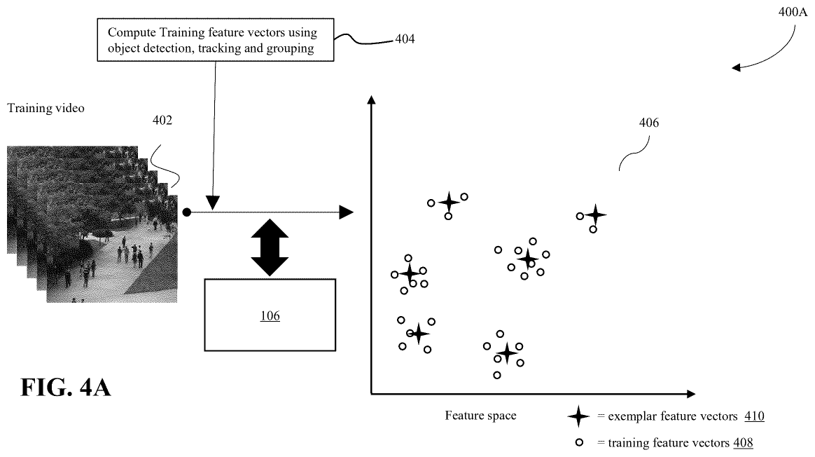

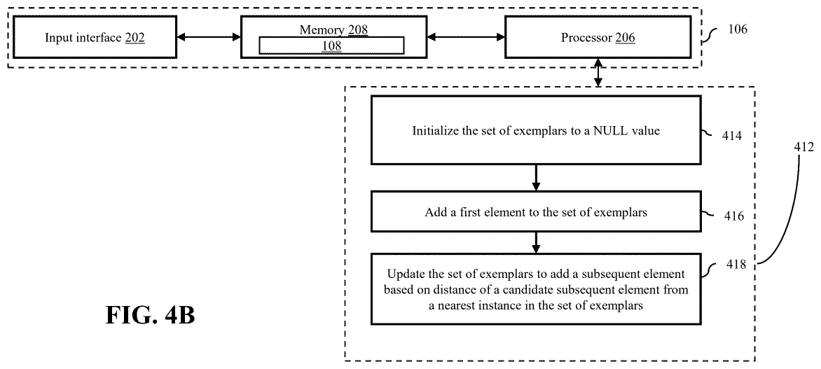

FIG. 4A illustrates a schematic diagram 400 showing a selection algorithm for the set of exemplars 108 from a large set of training feature vector groups, according to an embodiment of the present disclosure. FIG. 4A is explained in conjunction with elements from FIG. 1, FIG. 2, and FIG. 3.

In an embodiment, the exemplars are selected at a training time, and the selected exemplars are then stored as the set of exemplars 108 in the system 106 and/or the database 114 for access during an execution time or in real-time by the system 106. To that end, the system 106 receives one or more frames of a training video 402, and the one or more frames are processed by an object detector and object tracker, followed by a grouping operation, to compute 404 training feature vectors 408 containing components that represent an object's appearance, size, location, and motion. The training feature vectors 408 exist in a feature space 406. A feature space is generally a mathematical space which represents features or attributes of a given dataset, for example, in the current embodiment these attributes are object attributes related to the object's appearance, size, location, trajectory or motion, and the like. Each observation in the feature space is represented in the form of a vector. The feature space 406 is a 3D space and objects that are close together in this 3D space are grouped together to form groups of feature vectors. Some embodiments use a clustering algorithm as the selection algorithm to select a subset of all training feature vector groups called exemplar feature vectors 410 as the set of exemplars 108. For example, in some implementations, the set of exemplars 108 has the property that every training feature vector group is close to at least one exemplar and no two exemplars are close together.

FIG. 4B illustrates a method implemented by the system 106 for selection of the set of exemplars 108, according to an embodiment of the present disclosure. In an embodiment, the system 106 performs the selection of the set of exemplars 108 based on the different frames of the normal video of the scene 102. In an embodiment, the exemplar selector 220 shown in FIG. 2 is configured to execute an exemplar selection algorithm corresponding to a method 412. To that end, the system 106 may receive the training video 402 which is the normal video of the scene 102, via the input interface 202. In an embodiment, the training video 402 is part of a dataset of videos collected for the purpose of training the system 106 and stored in the database 114 and accessed at the time of training of the system 106.

The processor 206 is configured to access the training video 402 and execute the method 412 for selection of the set of exemplars 108 according to an embodiment of the present disclosure. The set of exemplars 108 may be designated as a set S for the purpose of description within this embodiment. The method 412 includes various operations that are executed by the processor 206. The operations include, at 414, initialization of the set of exemplars 108, S, to a null value. Once the set of exemplars 108 is initialized, at 416, a first element is added to the set S. The first element may be any of the training feature vectors 408. The training feature vectors 408 are computed based on objects detected in the training video and exemplars are selected from the training feature vectors 408.

Thereafter, at 418, the set of exemplars 108 is updated to add a subsequent element to the set based on a distance condition. The distance condition includes checking a distance of a candidate subsequent element from the set of training feature vectors 408 to a nearest instance in the current set of exemplars 108. The operation 418 may be executed iteratively until all the training feature vectors 408 in the feature space 406 are processed by checking against the distance condition. For updating the set of exemplars 108, each training feature vector 410 is selected as a candidate subsequent element to be added to the set of exemplars 108, and its nearest exemplar feature vector is identified as the nearest instance for this candidate subsequent element. The distance of this nearest instance is compared to a distance threshold, th. If the distance is more than the distance threshold, th, then the candidate subsequent element is added to the set of exemplars 108. If the distance is less than or equal to the distance threshold, then another feature vector from the training feature vectors 408 is selected as the candidate subsequent element and the process outlined above is repeated until all the training feature vectors 408 have been processed.

In an embodiment, the multiple frames of the training video 402 are used to compute a training feature vector set based on object detection and tracking done at different instant of time for different frames. An exemplar selection algorithm is run which selects a subset of the elements of the training feature vector set such that no two members of the subset are near each other according to a distance function. The intuition behind exemplar selection is to simply remove redundant (or nearly redundant) elements from the feature vector set leaving behind a compact, representative subset of exemplars. To that end, the processor 206 is configured to extract, from the different frames of the normal video, multiple normal exemplars including combinations of features indicative of the appearance and motion features of objects detected in the normal video using the process described above to produce the set of exemplars 108. Exemplar selection yields a compact representative set of exemplars 108 for storing in the database 114 or the memory 208 and using at execution time for the system 106.

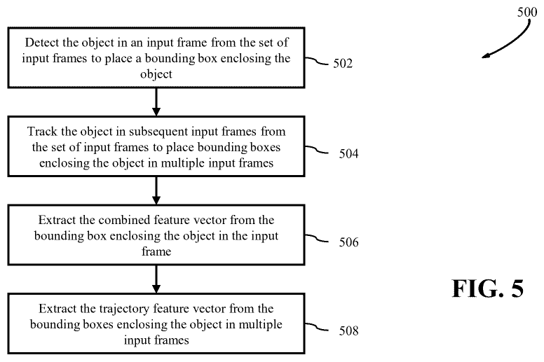

FIG. 5 illustrates a flowchart of a method 500 for determining features suitable for video anomaly detection according to some embodiments. FIG. 5 is explained in conjunction with elements from FIG. 1, FIG. 2, FIG. 3, FIG. 4A, and FIG. 4B. The method 500 may be executed by the processor 206, that may be configured to execute computer-executable instructions that include operations to perform steps of the method 500. In one embodiment, the object detector 210 is configured to include the computer-executable instructions to implement the method 500.

The method 500 includes operations to detect 502 an object in an input frame from a set of input frames of the input video 104. To that end, the input video 104 may be a real-time or test-time video of the scene 102 captured in real-time or near real-time. In another embodiment, the input video 104 is the training video 402 of normal activity of the scene 102, captured during training of the system 106. The input frame may include one or more objects, and the processor 206 may be configured to place a bounding box around the object.

The method 500 further includes operations to track 504 the object in other input frames from the set of input frames and place bounding boxes around the object in multiple input frames. For each object that is detected 502 and tracked 504, a combined feature vector including various appearance and motion features are computed. An appearance feature vector is extracted 506 from the image patch within the detected bounding box. A size feature vector and a location feature vector are also extracted from the detected bounding box. A trajectory feature vector is extracted 508 from the object tracking 504 which provides bounding boxes enclosing the object in multiple input frames. These extracted features are used as suitable features for video anomaly detection, enabling the identification of abnormal events or behaviors in video surveillance systems.

Some embodiments are based on recognizing that in recent years, there has been a significant advancement in the field of machine learning, particularly with the development of neural networks. Neural networks are computational models inspired by the structure and function of the human brain. They include interconnected nodes, or artificial neurons, that process and transmit information. By training neural networks with substantial amounts of labeled data, they can learn to recognize patterns and make predictions or classifications.

Machine learning techniques, such as neural networks, have been applied to object detection and tracking tasks with promising results. These methods can automatically learn relevant features from the input data, eliminating the need for manual feature engineering. By training neural networks with labeled data, they can learn to detect objects and accurately determine their trajectories.

However, while machine learning-based approaches have shown great potential, there are still challenges to be addressed. These include the need for large amounts of labeled training data, the computational complexity of training and inference, and the interpretability of the learned models. However, some embodiments are based on the understanding that neural networks trained for various tasks not related to video anomaly detection can be adapted and/or reused to extract the appearance and trajectory features. To that end, the system 106 includes the one or more neural networks 212 that may be configured to extract the trajectory features of the object in the scene 102 based on the tracking of the object such that the trajectory features are indicative of the trajectory of the object in the scene 102, the trajectory including data associated with a displacement of the object from one frame to the next across multiple consecutive frames of the set of frames of the input video 104.

In one or more embodiments, the processor 206 is configured to execute the one or more neural networks 212 to detect the object in the input frame of the input video 104 from a set of input frames of the input video 104 to place the bounding box enclosing the object. The one or more neural networks 212 further cause the processor 206 to track the object in other input frames from the set of input frames to place bounding boxes enclosing the object in multiple input frames and extracting the combined features from the bounding box enclosing the object in the input frame. The one or more neural networks 212 further cause the processor 206 to extract the trajectory features from the bounding boxes enclosing the object in the multiple input frames. The one or more neural networks 212 are trained with machine learning.

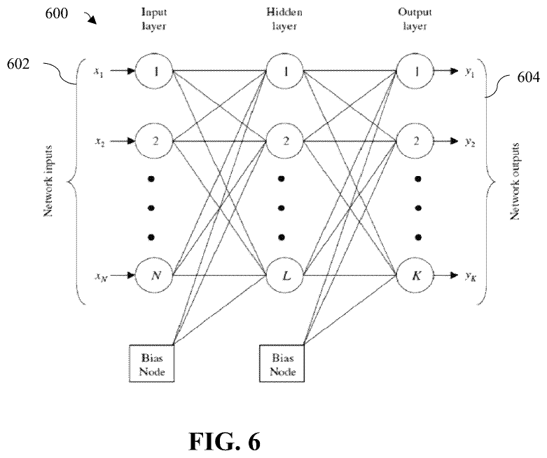

FIG. 6 illustrates a schematic diagram of a neural network 600, according to some embodiments of the present disclosure. Each of the one or more neural networks 212 may be based on an architecture similar to the neural network 600. The neural network 600 may be a network or circuit of an artificial neural network, composed of artificial neurons or nodes. Thus, the neural network 600 is an artificial neural network used for solving artificial intelligence (AI) problems. The connections of biological neurons are modeled in the artificial neural networks as weights between nodes. A positive weight reflects an excitatory connection, while a negative weight value means inhibitory connections. All inputs 602 of the neural network 600 may be modified by weight and summed. Such an activity is referred to as a linear combination. Finally, an activation function controls the amplitude of an output 604 of the neural network 600. For example, an acceptable range of the output 604 is usually between 0 and 1, or it could be −1 and 1. The artificial networks may be used for predictive modeling, adaptive control, and applications where they may be trained via a training dataset. Self-learning resulting from experience may occur within networks, which may derive conclusions from a complex and seemingly unrelated set of information.

Training a neural network with machine learning involves teaching the model to recognize patterns and make predictions based on data. The training with machine learning may include various tasks such as data collection, preprocessing, building a model, forward pass, loss function determination, backpropagation, optimization of weights, iteration, and testing.

Each of the one or more neural networks 212 may be trained to perform various operations such as extraction of appearance features, extraction of context features, selection of the set of exemplars 108, identification of anomaly based on appearance features, context features, the set of exemplars, and the like, using the principles of machine learning outlined above.

In an embodiment, the one or more neural networks 212 comprise a neural network for detecting the object in a frame of the input video 104.

In an embodiment, the one or more neural networks 212 comprise a neural network for tracking the object in the input video 104.

In an embodiment, the object detector 210 (shown in FIG. 2) comprises a neural network of the one or more neural networks 212 that performs object detection and tracking. In another embodiment, the object detector 210 comprises different neural networks from the one or more neural networks for performing object detection and object tracking, respectively.

In an embodiment, the one or more neural networks 212 include a convolutional neural network, a transformer network and the like.

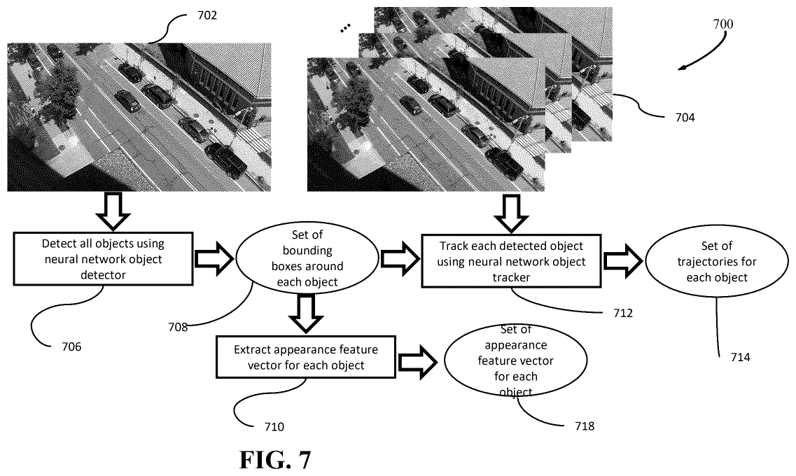

FIG. 7 illustrates a schematic of a method 700 for detecting objects in an image and tracking objects in one or more images, according to an embodiment of the present disclosure. FIG. 7 is explained in conjunction with elements from FIG. 1, FIG. 2, FIG. 4A, FIG. 5, and FIG. 6.

In an embodiment the method 700 is executed by the processor 206 to cause the processor to detect the object in an input image 702. The input image 702 may correspond to a frame of the input video 104. To that end, the processor is configured to extract appearance, size, and location features for each object, and determine the trajectory of each object using multiple neural networks trained with machine learning according to some embodiments.

The method 700 includes detection 706 of all objects of interest by execution of a neural network trained for object detection on the input image 702. For example, one of the one or more neural networks 212 is executed to detect the object of interest in the input image 702. The input image 702 corresponds to a frame of the input video 104 at a particular instance of time.

The neural network trained for object detection (hereinafter also referred to interchangeably as object detection network 706) outputs a set of bounding boxes 708 giving the size and location of each detected object. Further, the combined features are extracted 710 from the object detection network 706 in the form of combined feature vectors. In an embodiment, the combined feature vectors are extracted from a separate object recognition neural network that takes an image patch defined by an object bounding box as input and outputs a set of appearance feature vectors 718 for the object. The object bounding boxes as well as subsequent video frames 704 are then input to a neural network 712 trained to track objects (hereinafter also referred to interchangeably as the neural network object tracker 712). The neural network object tracker 712 outputs a set of trajectories 714 for each detected object. A trajectory consists of a list of horizontal and vertical displacements of the center of the object bounding box for a fixed number of frames of video. By leveraging the capabilities of machine learning, the method 700 provides accurate and efficient object detection and trajectory determination.

In an embodiment, the method 700 is executed to extract context features in a manner similar to the manner described above.

In the context of extracting appearance features from an image patch containing an object wherein the image patch is defined by a bounding box in an input image, deep neural networks have been utilized to learn discriminative representations of object appearances. By training the network on a large dataset of image patches containing objects, the network can learn to extract features that are highly informative for object classification. Such neural networks typically have an embedding layer (typically the penultimate network layer) which is a feature vector that is then mapped to a set of object class probabilities that estimate the probability that the input image patch contains each of the known object classes on which the neural network is trained. Some embodiments are based on recognizing that while these methods can focus on using the output of the final layer (class probabilities) of the network as the appearance features, these methods can be suboptimal when the object appearing in the scene is absent from the training dataset. In the case where the input image contains an unknown object not in the training set, the feature vector in the embedding layer may still be indicative of the object class even though the output class probabilities are unable to express the unknown class. To address these issues, some embodiments use the output of the embedding layer of the deep neural network as the appearance feature vector. In such a manner, the relevant appearance features can be extracted even for the previously unseen object in a standard manner. The object recognition neural network for computing appearance features can be an independently trained neural network that takes as input an image patch extracted from an input image according to an object detection bounding box. Alternatively, the object recognition neural network is a part of a larger object detection neural network that both localizes objects in an input image and recognizes the object class of each detected object.

In an embodiment, to extract the set of trajectories 714 of each object in the input image 702, the processor 206 is configured to extract the trajectory features from the bounding boxes enclosing the object in multiple input frames. Further, the coordinates of pixels at the center of each of the bounding boxes is determined to form a sequence of coordinates.

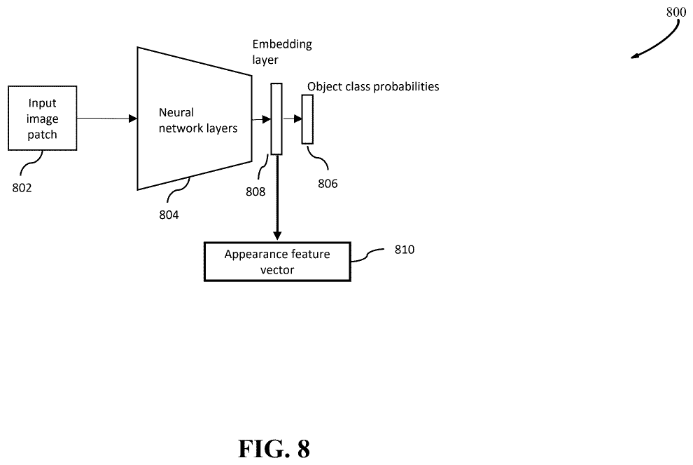

FIG. 8 shows a schematic diagram of a method 800 for extracting appearance features from an image patch of an object defined by a bounding box from an input frame according to some embodiments.

The method 800 also includes taking as input an image patch 802 and applying neural network layers 804 to it which results in an embedding layer 808 which is a feature vector that is indicative of the class of the object. The embedding layer 808 is used to compute class probabilities 806. The feature vector of the embedding layer 808 is used as an appearance feature vector 810 in some embodiments. This method enables the extraction of appearance features that can be used for various applications, including video anomaly detection.

Some embodiments use various methods for extracting trajectory features from the input video 104. A trajectory feature for an object detected in a video frame consists of a list of (x,y) displacements of the center of the object's bounding box in the F consecutive frames: {(xᵢ, yᵢ)}_{i=1:F}. F is a whole number parameter chosen depending on the application.

There are many methods for tracking multiple objects in video used by different embodiments. Examples of object-tracking methods include visual tracking methods, tracking by detection methods, and optical flow-based methods. Visual tracking methods use the appearance of the object in the first frame and try to find similar appearances in subsequent frames. Tracking by detection methods use the bounding boxes output by an object detector applied to all the frames and associate bounding boxes from one frame to the next. Optical flow-based methods first compute the pixel-wise optical flow between all frames and then use the pixel-wise displacements to track an object.

Some embodiments use various methods for extracting trajectory features from multiple bounding boxes by analyzing the motion vectors between consecutive frames to determine the direction and speed of an object's movement. These methods typically involve tracking the movement of individual pixels within the bounding boxes and calculating the displacement between consecutive frames. However, these methods may suffer from inaccuracies and limitations in capturing the complete trajectory information due to the reliance on pixel-level tracking.

Alternative embodiments use optical flow algorithms to estimate the motion vectors between frames. Optical flow algorithms analyze the changes in pixel intensities between consecutive frames to determine the direction and magnitude of motion. While optical flow methods can provide more accurate motion estimation, they often struggle with handling occlusions, rapid motion, and complex scenes, which can lead to errors in trajectory feature extraction.

Alternative embodiments utilize object detection algorithms to identify and track objects within the bounding boxes. These algorithms typically rely on machine learning models trained on large datasets to detect and track objects based on their visual appearance. Some embodiments, however, overcome these limitations by determining the trajectory features from multiple bounding boxes using a combination of the sequence of coordinates and motion vectors connecting neighboring coordinates. By incorporating both spatial and temporal information, the method of these embodiments provides a more accurate and comprehensive representation of the trajectory features.

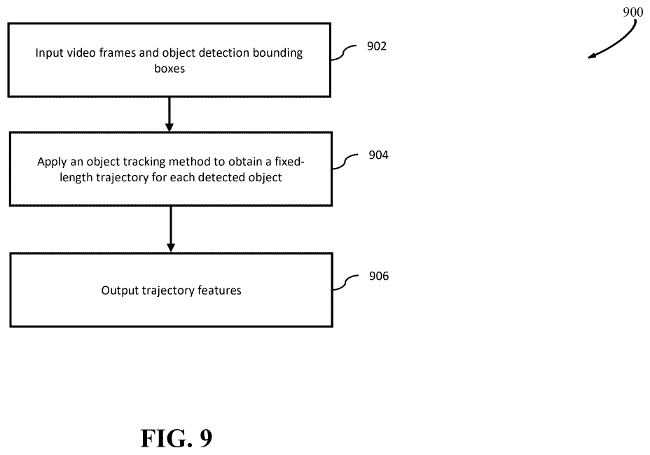

FIG. 9 shows a flowchart of a method 900 for extracting the trajectory features from frames of the input video 104, according to an embodiment of the present disclosure. The method 900 may be executed by the processor 206. Alternatively, the method 900 may be executed by the feature extractor 214 shown in FIG. 2. The object detector 210 (shown in FIG. 2) is trained to detect the object in the frame of the video 104 and place the bounding box around it. Thus, the method 900 includes, at 902, receiving the input video frames 104 and performing object detection on all frames by placing the bounding boxes of objects detected by an object detector in all frames.

The method 900 further includes, at 904, applying an object tracking method. To that end, any of the processor 206, the object detector 210, and the one or more neural networks 212 may be configured to apply the object tracking method. The resulting trajectory features {(xᵢ, yᵢ)}_{i=1:F} 906 for each detected object are output by the object tracking method 900. The trajectory features are indicative of the trajectory of the object in the scene 102, the trajectory including data associated with a displacement of the object from one frame to the next across multiple consecutive frames of the set of frames of the input video 104.

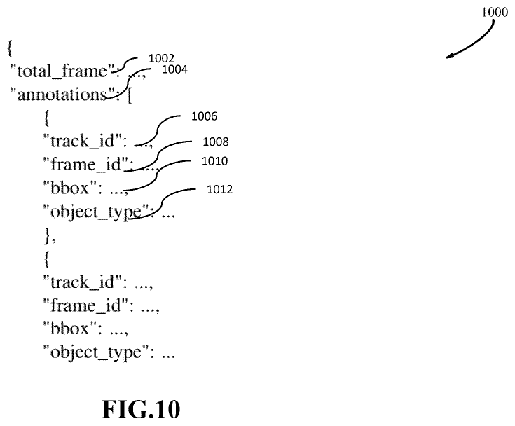

FIG. 10 illustrates a diagram showing exemplary code 1000 including data extracted from different frames of the input video 104, according to an embodiment of the present disclosure.

In an embodiment, the data extracted from each of the different frames of the input video 104 includes a total_frame data field 1002 that represents the total number of frames in the input video 104. Further, an annotations field 1004 contains the list of each annotated object in every frame. In an example, every object may contain different properties: like a track_id 1006, which is a unique id for the object, a frame_id 1008 which is a frame number of the object, a bbox 1010 data which includes coordinates of the bounding box of the object in the format of [x1, y1, x2, y2] where (x1, y1) is the coordinate of top-left and (x2, y2) is the coordinate of top-right for the bounding box, and an object_type 1012 which represents a type of the object i.e., person, skateboard, etc. A unique track_id represents the same object through different frames. If a particular object is present in consecutive frames, the corresponding annotations will have the same track_id 1006 but different frame_id 1008 and bbox 1010 values.

In an embodiment different frames of the input video 104 may include different objects, such as a first object and second object, and data may be extracted from the different frames for each of the different objects as described above. The data is then used to detect and track the objects in different frames of the input video 104.

The data is then further used to compare features of the object in the frames of the input video 104 to features of exemplars extracted from frames of the normal video of the scene 102 and thereafter anomaly detection is performed based on the comparison.

FIG. 11 illustrates a block diagram 1100 of a system for video anomaly detection including multiple objects in the scene 102, according to an embodiment of the present disclosure. The system shown in FIG. 11 is equivalent to the system 106 discussed in previous embodiments. As discussed previously, the system 106 includes the memory 208 that stores the set of exemplars 108 which include features of different objects extracted from a normal video (such as the training video 402) of the scene 102. The normal video of the scene may include a first object o1 and a second object o2, and the features for first object o1 and the second object o2 are extracted from bounding boxes of the first object tracked in different frames of the normal video of the scene 102 and combined with features of the second object o2 of the normal video of the scene 102, such that the second object o2 is in close proximity to the first object.

In an example, the input video 104 comprises a set of frames 1102, that are captured by an image capturing device, such as the data capturing devices 116 shown in FIG. 1 and FIG. 2, and the set of frames 1102 include the first object o1 and the second object o2. Thereafter, using the object detection and object tracking methodologies described previously in various embodiments, the first object o1 moving in the input video 104 of the scene 102 is detected by placing bounding boxes on the first object o1 in the set of frames 1102 of the input video 104. For example, bounding box b1 corresponding to the first object o1 is used to initialize a track of the first object o1 in the set of frames 1102 of the input video 104 of the scene 102.

Similarly, the second object o2 moving in the input video 104 of the scene 102 is detected by placing bounding boxes on the second object o2 in the set of frames 1102 of the input video 104. For example, bounding box b2 corresponding to the second object o2 is used to initialize a track of the second object o2 in the set of frames 1102 of the input video 104 of the scene 102. Accordingly, there are different bounding boxes for each of the first object o1 and the second object o2 in different frames in the set of frames 1102. For the sake of brevity, only a single frame and its corresponding bounding boxes b1 and b2 are shown in FIG. 11.

Thereafter features of the first object o1 and the second object o2 are extracted. For example, the feature extractor 214 shown in FIG. 2 is used to store instructions to cause the processor 206 to extract the features of the first object o1 and the second object o2.

In an example, the feature extractor 214 causes execution of one or more neural networks (such as from the one or more neural networks 212 shown in FIG. 2) to cause extraction of the features of the first object o1 and the second object o2. For example, as shown in FIG. 11, a first neural network 1106 is used to extract the features of the first object o1, and a second neural network 1104 is used to extract the features of the second object o2.

The features of the first object o1 form combined features 1110 of the first object o1 in the scene 102 that are extracted the detected bounding box b1 of the first object o1 in the set of frames 1102. The combined features 1110 are indicative of an appearance of the first object o1 in the scene 102, a size of the first object o1 in the scene 102, a location of the first object o1 in the scene 102, and a trajectory of the first object o1 within the scene 102. For example, the extraction of features was discussed previously in conjunction with FIG. 8.

Further, the features of the second object o2 that are extracted by the second neural network 1104 form context features 1108 because they provide a context for the presence of the first object o1 in the scene 102. In an example, the context is the interaction between the first object o1 and second object o2. In another example, the context is the proximity of the first object o1 and the second object o2. The context features 1108 are in turn combined features of the second object o2 in the scene 102 that are extracted from the set of frames 1102 of the input video 104 outside of the bounding boxes of the first object o1. Thus, the context features 1108 are indicative of an appearance of the second object o2 in the scene 102, a size of the second object o2 in the scene 102, a location of the second object o2 in the scene 102, and a trajectory of the second object o2 within the scene 102. For example, the extraction of features was discussed previously in conjunction with FIG. 8.

The combined features 1110 and the context features 1108 are combined 1112 to generate an input feature vector 1114. The combination 1112 may include any concatenation operation, a summation operation, a product operation, and the like.

The input feature vector 1114 is used for comparison with a closest exemplar from the set of exemplars 108, in order to detect an anomaly in the scene 102.

FIG. 12 illustrates a block diagram of a method 1200 for anomaly detection, according to an embodiment of the present disclosure.

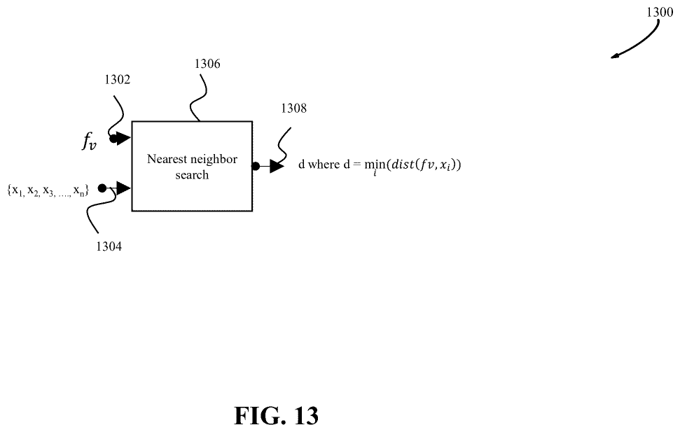

The method 1200 includes a comparison 1202 of the input feature vector 1114 that is formed as a result of combining of combining of combining of the combined features 1110 and the context features 1108, with a closest exemplar 1204. The closest exemplar 1204 has exemplar combined features 1206 and exemplar context features 1208, which in combination model the interaction of the combined features 1110 and the context features 1108 most closely. The closest exemplar 1204 is derived from the set of exemplars 108 based on a comparison of the input feature vector 1114 with each exemplar in the set of exemplars 108. This was discussed previously in conjunction with FIG. 3 and is further explained in FIG. 13.

As a result of the comparison 1202, a smallest distance 1210 from the input feature vector 1114 to its closest exemplar 1204 is determined. For example, the distance calculator 110 (shown previously in FIG. 1 and FIG. 2) determines the distance between the input feature vector 1114 and the closest exemplar 1204 using a distance function. This distance is termed as the smallest distance 1210. Further, the smallest distance 1210 may be a numerical value, an integer value, a rational number, and the like. The smallest distance 1210 is then used to output the anomaly detection result 112, based on a comparison of the smallest distance 1210 with a threshold. The threshold may be again any of the numerical value, the integer value, the rational number, and the like. The anomaly detection result 112 is indicative of a presence of an anomaly or an absence of an anomaly, for performing the video anomaly detection in the scene 102.

In an embodiment, processor 206 is configured to execute the method 1200 to generate the anomaly detection result 112. To that end, to determine the smallest distance 1210 from the input feature vector 1114 to its closest exemplar 1204, the processor 206 is configured to determine distance values of the input feature vector 1114 from each exemplar in the set of exemplars 108. From these distance values, the smallest value is selected as the smallest distance 1210 value. Further, an exemplar which corresponds to this smallest distance 1210 value is determined as the closest exemplar 1204.

In an embodiment, based on the determined smallest distance 1210 value, an anomaly score is assigned to the input feature vector 1114. To that end, the smallest distance 1210 value forms the anomaly score for the input feature vector 1114. This anomaly score is compared with the threshold. If the anomaly score, that is the smallest distance 1210 value is greater than the threshold, the anomaly detection result 112 is indicative of the presence of the anomaly in the scene. However, when the anomaly score, which is the smallest distance 1210 value is lesser than or equal to the threshold, the anomaly detection result 112 is indicative of the absence of the anomaly in the scene. In an example, to indicate the presence of the anomaly in the scene 102, the anomaly detection result 112 may be assigned a value of 1, while to indicate the absence of the anomaly in the scene 102, the anomaly detection result 112 may be assigned a value of 0. It may be understood that these values of 1 and 0 for the anomaly detection result are provided only for the sake of example, and not to limit the scope of the present disclosure. Any equivalent values may be assigned to the anomaly detection result 112 without deviating from the scope of the present disclosure.

FIG. 13 illustrates a schematic of a method 1300 used for determining the closest exemplar 1204, according to an embodiment of the present disclosure. FIG. 13 is explained in conjunction with elements from FIG. 1, FIG. 2, and FIG. 12. In an embodiment, the method 1300 is implemented by the system 106, such as by causing the processor 206 to execute one or more computer-executable instructions that cause the processor 206 to perform operations described for the method 1300. The method 1300 is a nearest neighbor search method used by some embodiments to find the closest exemplar 1204 to the input feature vector 1114. The method 1300 includes an input feature vector fᵥ 1302 which is equivalent to the input feature vector 1114, and each xᵢ 1304 is an exemplar, such as one of the exemplars from the set of exemplars 108. The method 1300 includes a nearest neighbor search 1306 algorithm that outputs a minimum distance, d, 1308 between fᵥ and the nearest xᵢ. Different embodiments use different nearest-neighbor searches. For example, one embodiment uses brute force search to compare each input feature vector with each training feature vector or exemplar feature vector. In some implementations, the nearest neighbor search 1306 is an approximate nearest neighbor search, which is not guaranteed to find the minimum distance but may instead find a feature vector that is close to the minimum. Various nearest neighbor search algorithms known in the art could be used such as k-d trees, k-means trees, locality-sensitive hashing, and the like, as the nearest neighbor search 1306 algorithm.

The method 1300 may be implemented by the system 106 used to detect an anomaly in the scene 102, by processing the input frames of the input video 104.

In some embodiments, the system 106 is configured to transform the input frames into a graph, such as a scene graph.

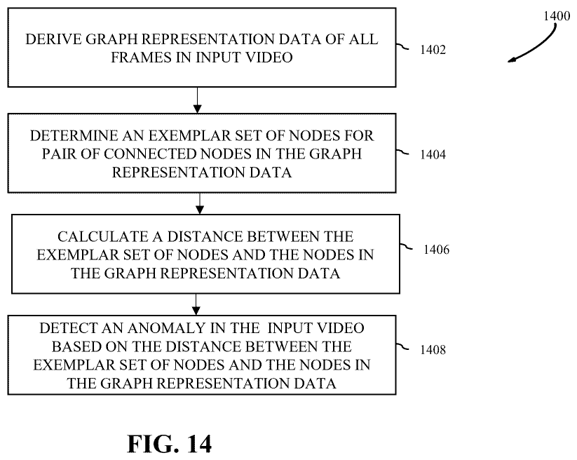

FIG. 14 illustrates a method 1400 for transforming the frames of the input video 104 into a graph representation and then performing anomaly detection, according to an embodiment of the present disclosure. The method 1400 may be implemented by the processor 206 shown in FIG. 2.

The method 1400 includes, at 1402, deriving graph representation data for all frames of the input video 104. The input video 104 may be any of a test time video or a training video. In one embodiment, deriving the graph representation data comprises transforming the input feature vector, such as the input feature vector 1114 shown in FIG. 11, to a scene graph. The scene graph comprises a spatio-temporal scene graph corresponding to the scene 102, such that the spatio-temporal scene graph includes nodes representing one or multiple static objects in the scene 102 and one or multiple dynamic objects in the scene 102. The derivation of the scene graph is explained in conjunction with FIG. 15A. Further, from the graph representation data, a pair of connected nodes from the nodes of the scene graph is determined. The pair of connected nodes may be associated with the appearance features 1110 and the context features 1108 shown in FIG. 11.

The method 1400 further includes, at 1404, determining an exemplar set of nodes for the pair of connected nodes in the graph representation data. The exemplar set of nodes may be selected by the exemplar selection algorithm discussed previously in conjunction with FIG. 4A and FIG. 4B.

Further, the method 1400 includes, at 1406, calculating a distance value between the exemplar set of nodes, such as the set of exemplars 108, and the pair of connected nodes in the graph representation data. For example, the distance calculator 110 discussed previously in conjunction with FIG. 1, FIG. 2, FIG. 12, and FIG. 13, determines the distance value. Based on the determined distance value, at 1408, an anomaly detection result is determined, such as the anomaly detection result 112 discussed previously, is outputted. The output is based on the comparison of the distance value distance with the threshold. This has been discussed previously in conjunction with FIG. 1, FIG. 2, FIG. 12, and FIG. 13.

In an embodiment, the graph representation also comprises a set of isolated nodes. The isolated nodes are not connected with any other nodes in the graph representation data. To that end, the set of exemplars 108 comprises a subset of exemplars for isolated nodes, and the distance value for the isolated nodes may be determined based on comparison of the subset of exemplars of isolated nodes with the isolated nodes. Subsequently, the anomaly detection result for the isolated nodes is generated.

The graph representation data includes data graph nodes, which may include pairs of connected nodes, group of nodes, isolated nodes, and a combination thereof. The graph may be a scene graph, and each of the nodes of the scene graph comprises a high-level representation of the object represented by that node, and which includes a set of attributes, the set of attributes comprising a bounding box size, a class identifier, a location, a trajectory vector, and a pose vector. To that end, a distance between any two nodes of the scene graph is a combination of distances between the set of the attributes corresponding to each of the nodes, wherein each of the two nodes is one of the nodes of the scene graph.

FIG. 15A illustrates a block diagram of a method 1500 for transformation of frames of the input video 104 into graph representation data, according to an embodiment of the present disclosure.

The input video 104 comprises a plurality of frames 1502. In an example, each 10th frame of each input video 104 is transformed into an undirected graph. The method 1500 shows a pipeline of the frame to graph transformation. In step 1, an object detector 1504 extracts objects from each of the plurality of frames 1502. For example, the object detector 210 shown in FIG. 2 may be used to extract the objects.

In an embodiment, a video V, such as the input video 104 is a collection of M frames, such as the plurality of frames 1502, which are denoted as

$${\{ {F}_{i} \}}_{i}^{M} = 1 ,$$

such that V=[F₁, F₂, . . . , F_{M}]. Each frame Fᵢ is sent to the object detector 1504 O, which returns X number of detected objects 1506. For each object o, the location l=(xₒ, yₒ) which is the x and y coordinates of the center of the object, b=(wₒ, hₒ) which is the width and height of the bounding box for the object, and class id c. The output of the object detector is then O(F)=[o₁, o₂, . . . , o_{X}], where each object oᵢ is represented by oᵢ=[b, c, l].

At step 2, after detecting objects 1506 in a frame, they are then tracked using an object tracker 1510. Each detected object o is sent to the object tracker 1510, which returns x and y coordinates for that object in the subsequent frames. In an example the objects are tracked for 30 frames. Therefore, for every object, a trajectory 1516 is acquired as θ={(x₁, y₁), (x₂, y₂), . . . , (x₃₀, y₃₀)}.

In addition to the object detector 1504 and the object tracker 1510, a pose estimator 1508 is also used to obtain pose information 1512 of human objects. Any object o identified as human is sent to the pose estimator 1508 to obtain the pose vector p={(x₁, y1), (x₂, y₂), . . . , (x₁₇,y₁₇)}, which contains the locations of 17 key points on the human body. In an embodiment, human pose estimation is done using the pose estimator 1508. The features extracted at step 4 for an object o are concatenated 1518 to form graph nodes 1520, where each node is defined as n=[b, c, l, θ, p] at step 5. Attributes 1514 of the object o include a node attribute b as the bounding box size, c is the class id, l is the location of the center of the object, θ is the trajectory vector and p is the pose vector.

Once the graph nodes 1520 are extracted, relations or context between the nodes are identified.

FIG. 15B illustrates a block diagram of a method 1500b for forming connections between interacting graph nodes 1520, according to an embodiment of the present disclosure.

At step 1 of the method 1500b, edges are found between nodes/objects that are likely to be interacting. The method 1500b uses a simple, thus computationally less intensive, and a more robust method of assigning an edge between objects if they are close to each other. That is to say, two objects are determined to be interacting if their distance in 3D space is below a threshold. Thus, to determine which nodes to connect in the graph 3D distances between each pair of nodes are calculated. To calculate the 3D distance between two nodes 3D coordinates of the node locations are derived by a pseudo 3D distance calculator by estimating a pseudo-depth since actual depth estimates are not known.

Given two nodes n₁ and n₂, their 2D coordinates l₁=(x₁, y₁) and l₂=(x₂, y₂). Further a relative depth, z, between two nodes is identified taking the absolute difference of y values such that z=|y₁−y₂|. This estimate of pseudo-depth assumes that objects are resting on the ground plane and the ground plane is farther from the camera the closer it is to the top of the image. The 3D distance d can then be calculated by taking the Euclidean distance between 3D coordinates (x₁, y₁, z) and (x₂, y₂, 0). Any node pair that has a 3D distance d smaller than a predetermined threshold h is connected with an edge E. For example, a node 1526 and a node 1530 are connected on the basis of their 3D distance 1528. Due to applying the threshold, not every single node is necessarily connected to another node, which leads to having isolated nodes in addition to node pairs. At the end of the frame to graph transformation, that is at step 2, a frame F which has a collection of objects [o₁, o₂, . . . , o_{X}] where X is the total number of objects extracted by the object detector for that frame, can be represented as a graph 1524, G=(N,E) where N is the collection of graph nodes [n₁, n₂, . . . , n_{X}], and E is the graph edges between connected nodes.

Similarly, a video V=[F₁, F₂, . . . , F_{M}] which contains M number of frames F, can be represented as collection of graphs: V=[G₁, G₂, . . . , G_{M}]. For efficiency, scene graphs are computed every 10th frame.

In an embodiment, for a given nominal video corresponding to the input video 104, frames are processed using the methods 1500a and 1500b and transformed into graphs. For every 10th frame in a video, all pairs of nodes that are connected by an edge are collected into one set and all isolated nodes (not connected to any other node) into another set. Then for each of the sets, independently, an exemplar selection algorithm is run which selects a subset of the elements of the set such that no two members of the subset are near each other according to a distance function (described below). The intuition behind the exemplar selection is to simply remove redundant (or nearly redundant) elements from the set leaving behind a compact, representative subset of exemplars. The same exemplar selection algorithm as described in conjunction with FIG. 4A, and FIG. 4B is used. The exemplar selection is run separately on the set of all isolated nodes found in the graphs 1524 of all frames and the set of all pairs of nodes found in the graphs 1524 of all frames.

To use the exemplar selection algorithm, a distance between two isolated nodes and a distance between two node pairs is identified. A graph node, n, is a high-level representation of an object which includes the attributes [b, c, l, p] where b is the bounding box size, c is the class identifier, l is the location, T is the trajectory vector and P is the pose vector. For two given nodes n1 and n2 with attributes [b1, c1, l1, θ1, p1] and [b2, c2, l2, θ2, p2], a distance between each node attribute is described The location distance is the Euclidean distance between 11=(x1, y1) and l2=(x2, y2): L(n1, n2)=p (x1−x2) 2+(y1−y2) 2 (1). The distance between bounding box sizes b1=(w1, h1) and b2=(w2, h2) is calculated by taking the Euclidean distance between each bounding box width and height normalized by the minimum width and height: S (n1, n2)=s (w1−w2) 2 min (w1, w2)+(h1−h2) 2 min (h1, h2) (2). The class distance is set to 0 if the nodes have the same class id; otherwise, it is set to 1. C(n1, n2)=0 if c1=c2, 1 if c1/=c2, (3). For two pose vectors, P1={(x1,1, y1,2), (x1,2, y1,2), . . . , (x1,17, y1,17)} and P2={(x2,1, y2,2), (x2,2, y2,2), . . . , (x2,17, y2,17)}, The pose distance is P (n1, n2). For two node trajectories θ1={(x1,1, y1,1), (x1,2, y1,2), . . . , (x1,30, y1,30)} and θ2={(x2,1, y2,1), (x2,2, y2,2), . . . , (x2,30, y2,30)}, the trajectory distance is the sum of the L1 distances between the displacements of the first node and the displacements of the second node normalized by the minimum displacement: Θ (θ1, θ2). Given these distances between attributes of two nodes, the final distance between two isolated nodes is calculated as follows: D(n1, n2)=max(L(n1, n2)−μL σL, S(n1, n2)−μS σS, C(n1, n2)−μC σC, P(n1, n2)−μP σP, Θ(n1, n2)−μΘ σΘ), where the μ and a parameters are normalization constants for each distance which make all the distances comparable. A node pair N is a combination of two nodes which are connected with an edge. Between two node pairs N1=(n1, n2) and N2=(n3, n4), the distance is calculated as follows: Dpair(N1, N2)=min(max(D(n1, n3), D(n2, n4)), max(D(n1, n4), D(n2, n3))). The intuition behind this distance is firstly that it is not known whether n1 corresponds to n3 or n4 (and similarly whether n2 corresponds to n3 or n4) so both pairings are tried, and the minimum distance is taken. This corresponds to the outer min function. For a given correspondence, the overall distance between the two node pairs is the maximum distance between the corresponding nodes from each pair. This is represented by the inner max functions. Further each attribute distance is normalized by subtracting the mean and dividing by the standard deviation. For this pairs of nodes computed from the nominal video of a dataset are used for computing each attribute's distance distribution for that dataset. The resulting normalized distances are less than 0 if two nodes are similar (raw attribute distance less than the mean), and greater than 1 if two nodes are significantly different (raw attribute distance greater than the mean plus standard deviation).

In some embodiments, the graphs 1524 corresponding to different frames of the input video 104 are obtained using a scene-aware video encoder system.

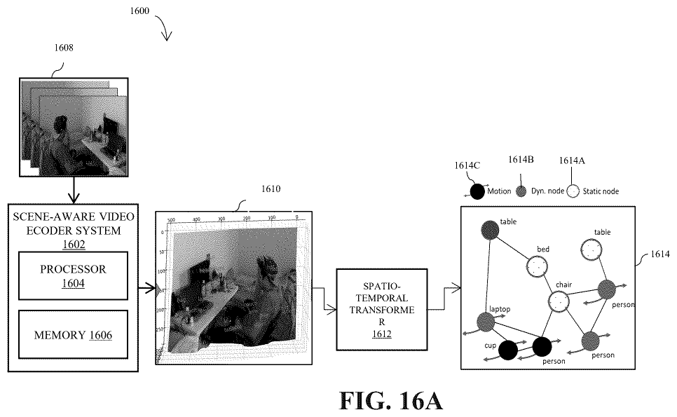

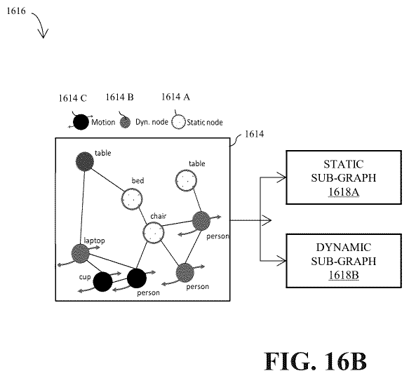

FIG. 16A shows a schematic diagram of 1600 of a scene-aware video encoder system 1602, according to some embodiments of the that are executed by the processor 1604 (which may be equivalent to the processor 206). The processor 1604 is configured to receive a sequence of video frames 1608 (interchangeably referred to hereinafter as video frames 1608). The sequence of video frames 1608 corresponds to the input video 104 of the scene 102. In some example embodiments, the sequence of video frames 1608 may be received via a network. The scene-aware video encoder system 1602 is equivalent to the system 106 of FIG. 1 and includes the processor 1604 and a memory 1606. The memory 1606 stores instructions.

The received sequence of video frames 1608 are pre-processed to output a pre-processed sequence of video frames 1610. The pre-processed sequence of video frames 1610 includes objects detected in the video frames 1608 as well as depth information of the objects in the video frames 1608. In some embodiments, the video frames 1608 may be pre-processed using an object detection model for object detection in each of the video frames 1608 and a neural network model for depth information estimation.

In some example embodiments, the object detection model may include a Faster Region Convolutional Neural Network (FRCNN) object detection model. The FRCNN object detection model may be pre-trained to detect objects in the video frames 1608. In some example embodiment, the FRCNN object detection model may be pre-trained based on a training dataset, such as Visual Genome dataset. The training dataset may be a broad array of daily-life indoor and outdoor objects. In each video frame, the FRCNN object detection model detects ‘m’ objects in the video frames 1608.

In some example embodiments, the neural network model (denoted as D:R^{h×w×3}→R^{h×w×4}) may be implemented using an off-the-shelf pre-trained 2D-to-3D deep learning framework. The 2D-to-3D deep learning framework may correspond to a MiDAS model for estimating a realistic depth for a variety of real-world scenes in an efficient and feasible manner. The neural network model receives each of the sequence of video frames 1608 as a Red, Green, Blue (RGB) image and outputs corresponding RGB image of each of the video frames 1608. For instance, a video frame is an RGB image (I), and corresponding depth information of the RGB image is, d_{I}:R²→R³ that maps a 2D pixel location (x, y) to a respective 3D coordinate, denoted p=(x, y, z).

The RGB images of the video frames 1608 output by the neural network model, and the detected objects of the video frames 1608 output by the object detection model are combined to output the pre-processed sequence of video frames 1610. The pre-processed sequence of video frames 1610 is inputted to a spatio-temporal transformer 1612.

The spatio-temporal transformer 1612 transforms each of the video frames 1608 into a spatio-temporal scene graph 1614 (G) of the video frames 1608 to capture spatio-temporal information of the video frames 1608. The spatio-temporal scene graph 1614 (G) for the sequence video frames 1608 (S) with a length of ‘n’ video frames may be represented as G=(V, E), where V=V₁∪V₂∪ . . . ∪Vₙ denotes a set of nodes, each Vₜ denotes a subset of nodes associated with frame t, and E⊆V×V denotes set of graph edges. The spatio-temporal scene graph 1614 is a pseudo 3D-structure, such as a 2.5D structure that includes nodes representing the detected objects ‘m’ of the video frames 1608. In particular, each of the ‘m’ objects is represented by a graph node ‘v’ that contains a tuple of FRCNN outputs (fᵥ^{o}, cv, bboxv) of the FRCNN object detection model, where fᵥ is the object's neural representation, cᵥ is corresponding label of an object in the training database, and bboxᵥ denotes corresponding bounding box coordinates relative to corresponding video frame of the sequence of video frames 1608. Thus, for the sequence of video frames 1608 with ‘n’ video frames, the spatio-temporal scene graph 1614 includes ‘mn’ graph nodes. The graph nodes of the spatio-temporal scene graph 1614 are encoded into a latent space by the spatio-temporal transformer 1612.

The graph nodes of the spatio-temporal scene graph 1614 includes one or multiple static nodes 1614A and one or multiple dynamic nodes 1614B. The one or multiple static nodes 1614A represent corresponding static objects in the video frames 1608. The one or multiple dynamic nodes 1614B represent corresponding dynamic objects in the video frames 1608. The one or multiple dynamic nodes 1614B includes motion features 1614C that represent information of movement of the dynamic nodes 1614B. In some example embodiments, the motion features 1614C are extracted from the dynamic graph nodes of the spatio-temporal scene graph using an action recognition model, e.g., an Inflated 3D networks (I3D) action recognition model.

In the spatio-temporal scene graph 1614 each of the graph nodes (static or dynamic) has properties that represent the corresponding object. For instance, a static graph node has properties that represent an appearance and a location of a corresponding static object. Likewise, a dynamic graph node has properties representing an appearance, a location, and a motion of corresponding dynamic object at different instances of time.

For a graph node v∈Vₜ extracted from a video frame at a time instance t (i.e., an image Iₜ), let bboxᵥ denotes a centroid of the node's detected bounding box. To enrich the spatio-temporal scene graph 1614 with (2.5+1)D spatio-temporal information, representation of the graph node (v) is incorporated with depth and time information. The depth and time information is incorporated to the graph node (v) by updating the tuple for the graph node (v) as

$$( {f}_{v}^{o} , {c}_{v} ,$$

bboxᵥ, pᵥ, t), where pᵥ=d_{It} b̅b̅o̅x̅ᵥ̅ is interpreted as a 3D centroid of the bounding box. The enriched spatio-temporal scene graph 1614 is denoted as G_{3.5D} graph.

Further, from the spatio-temporal scene graph 1614 (G_{3.5D} graph), graph nodes that correspond to the static objects are pruned to remove redundant or copy of the graph nodes, which is described next in FIG. 16B.

FIG. 16B shows a representation for segregation of the spatio-temporal scene graph 1614, according to some embodiments of the present disclosure. In some example embodiments, the spatio-temporal scene graph 1614 may be segregated based on the class segregation of the objects. The class segregation may correspond to the segregation of a training dataset (e.g., the training dataset of the FRCNN object detection model) into two categories. The two categories may include a category of static objects (Cₛ) and a category of dynamic objects (C_{d}). The category of static scene objects (Cₛ) may correspond to objects, such as a table, sofa, television, trees, traffic lights etc. The category of dynamic scene objects (C_{d}) may correspond to objects, such as people, mobile, football, clouds, etc. To that end, the spatio-temporal scene graph 1614 is split into a static sub-graph 1618A (Gₛ) and a dynamic sub-graph 1618B (G_{d}) corresponding to whether an object label (Cᵥ) of a graph node v∈V belongs to Cₛ or C_{d}. The static sub-graph 1618A includes graph nodes belonging to the category of static scene objects (Cₛ), while the dynamic sub-graph 1618B includes graph nodes belonging to the category of dynamic scene objects (C_{d}).

In some embodiments, the enriched spatio-temporal scene graph 1614 graph (G_{3.5D}) is registered in a shared 3D space. In some embodiments, features for the registration are extracted from the graph nodes of the static sub-graph 1618A (referred to hereinafter as static graph nodes) features for registration are extracted. The registration features are extracted from the static subgraph nodes to tackle problems due to motion of objects in the video frames 1608, and/or problems due to motion of a camera capturing the video frames 1608. Specifically, if there is camera motion, then there may be a frame-to-frame 3D projection matrix using point features. The projection matrix may be used to spatially map all the graph nodes (including both the static and the dynamic graph nodes) of the enriched spatio-temporal scene graph 1614 into a common coordinate frame.

Some embodiments are based on realization that bounding boxes that define objects in the static nodes may be imprecise. To that end, a criterion (C) to merge two static nodes may be checked. The criterion (C) may include checking whether the static nodes are from frames that are sufficiently close in time, with the same object labels, and with the intersection over union (IoU) of their bounding boxes above a threshold γ. In particular, two nodes (vt, vt′∈Gₛ) of the enriched graph, from frames with timestamps (t≠t′) such that (|t−t′|<δ), are candidates for merging if the following criterion (C) is met:

$$C ( {v}_{t} , {v}_{{t}^{′}} ) := ( {c}_{{v}_{t}} = {c}_{{v}_{{t}^{′}}} ) ∧ IoU ( {bbox}_{{v}_{t}} , {bbox}_{{v}_{{t}^{′}}} ) > γ \qquad ( 1 )$$

If a static graph node vₜ of the static sub-graph 1618A has multiple candidate nodes in previous δ frames of the video frames 1608 that satisfy the criterion (1), the candidate node with the nearest 3D centroid is selected as the matching node is merged:

$$match ( {v}_{t} ) = {v}_{{t}^{′}} ∈ {V}_{t - δ}^{s} ⋃ … ⋃ {V}_{t - 1}^{s} ‖ {p}_{{v}_{t}} - {p}_{{v}_{{t}^{′}}} ‖ such that C ( {v}_{t} , {v}_{{t}^{′}} ) = 1 \qquad ( 2 )$$

where,

$${V}_{t}^{s} = \{ {v}_{t} ∈ {V}_{t} \vert {v}_{t} ∈ {G}_{s} \}$$

denotes a set of all static nodes from frame t. The equation (2) selects a best match from previous δ frames that overcomes noise in estimation of the depth information and the bounding boxes associated with the graph nodes. In some example embodiments, the equation (2) may be recursively applied to the enriched graph to determine larger equivalence classes of matched nodes to be merged. An equivalence class may be defined as a set of all nodes that share a single common node, referred to as a common ancestor. The common ancestor may be accomplished by looping over frames t in temporal order, where for each node vₜ for which a match (vₜ) exists, the common ancestor node is assigned as, an ancestor (vₜ)=ancestor (match (vₜ)), using the following algorithm 1.

Algorithm 1: Identifying common ancestor nodes for merging

$for {v}_{1} ∈ {V}_{t}^{s} do$
ancestor (v₁) := v₁
for t = 2 to n do
$for {v}_{1} ∈ {V}_{t}^{s} do$
if match (v₁) exists then
ancestor (vₜ) := ancestor (match(vₜ))

Finally, for each ancestor, all graph nodes that share the same ancestor are merged into a single graph node. The feature

$${f}_{v}^{o}$$

associated with a new graph node (v) is obtained by averaging the features from all of the graph nodes that merged together. After each equivalence class of matched graph nodes are merged into the single graph node, an updated static sub-graph 1618A (G_{s′}) is obtained. The updated static sub-graph (G_{s′}) is a reduced version of the static sub-graph 1618A (Gₛ) as redundant static graph nodes are pruned. The pruning of the redundant static graph nodes may improve processing and computation speed scene-aware video encoder 1602.

Further, graph nodes of the dynamic sub-graph 1618B (referred to hereinafter as dynamic graph nodes) are incorporated with motion features (e.g., the motion features 1614C). In some example embodiments, the motion features may be incorporated using a neural network, such as I3D action recognition neural network. The I3D action recognition neural network may be pre-trained on dataset, such as Kinetics-400 dataset to generate convolutional features from the video frames 1608. The convolutional features may be pooled using a pooling technique (e.g., Region-of-Interest (ROI)). In particular, the convolutional features are ROI-pooled using the original bounding boxes associated with the dynamic graph nodes of the dynamic sub-graph 1618B. For instance, the convolutional features may be represented as,

$${f}_{{v}_{t}}^{a} = ROIPool ( I3D ( {s}_{t} ) , {bbox}_{{v}_{t}} ) \qquad ( 3 )$$

where sₜ denotes the video frames 1608 around the t-th video frame of the input video 104 (S), then a feature vector outputted by the FRCNN object detection model are augmented by concatenating the object and motion features as

$${f}_{v}^{oa} ← {f}_{v}^{o} \vert \vert {f}_{v}^{o} ,$$

for all v∈V_{d}, where ∥ is an operator for feature concatenation.

Further, in some embodiments, the spatio-temporal transformer 1612 encodes different combinations of different nodes of the spatio-temporal scene graph 1614 corresponding to different spatio-temporal volumes of the scene 102 into a latent space. The encoding of each node of the different nodes in each of the combinations is weighted with an attention score determined as a function of similarities of spatio-temporal locations of the different nodes in the combination.

In accordance with various embodiments described above, the system 106 may be used to efficiently detect anomalies in the scene 102 on the basis of modeling of groups of objects that are interacting in the scene 102. This enables more robust and faster anomaly detection by the system 106.

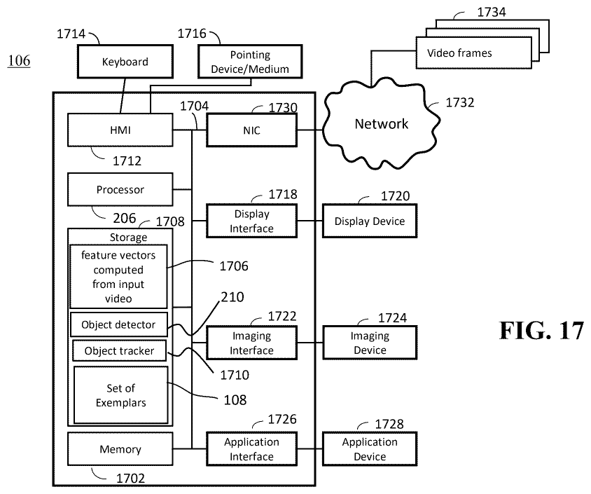

FIG. 17 illustrates a block diagram of the system 106 for detecting anomalies in videos coming from a fixed, static camera in accordance with some embodiments. The system 106 may be an image processing system that includes the processor 206 configured to execute stored instructions, as well as a memory 1702 that stores instructions that are executable by the processor. The processor 206 can be a single core processor, a multi-core processor, a computing cluster, or any number of other configurations. The memory 1702 can include random access memory (RAM), read only memory (ROM), flash memory, or any other suitable memory systems. The processor 206 is connected through a bus 1704 to one or more input and output devices. These instructions implement a method for detecting anomalies in a video sequence.

In various embodiments, anomaly detection produces a set of bounding boxes indicating the locations and sizes of any anomalies in each video frame. The system 106 is configured to detect anomalies in a video by comparing feature vectors 1706 computed from input video to exemplar feature vectors 108, referred to herein as the set of exemplars 108, stored on the storage device 1708 (may be equivalent to the memory 208 shown in FIG. 2 or the database 114 shown in FIG. 1) that were computed from training video of the same scene. The storage device 1708 can be implemented using a hard drive, an optical drive, a thumb drive, an array of drives, or any combination thereof. Feature vectors include appearance, size, and location components computed using an object detection neural network or the object detector 210 and a trajectory component computed using an object tracker 1710 (which is equivalent to the object tracker 211 shown in FIG. 2). In some embodiments, the object tracker 1710 is embodied within the object detector 210. The system 106 implements an anomaly detector that compares feature vectors computed from the input video to feature vectors of the training video of the same scene to declare anomalies when an input feature vector is dissimilar to all exemplar feature vectors from the training video.

In some implementations, a human-machine interface 1712 within the system 106 connects the system to a keyboard 1714 and pointing device 1716, wherein the pointing device 1716 can include a mouse, trackball, touchpad, joystick, pointing stick, stylus, or touchscreen, among others. The system 106 can be linked through the bus 1704 to a display interface 1718 adapted to connect the system 106 to a display device 1720, wherein the display device 1720 can include a computer monitor, camera, television, projector, or mobile device, among others.

The system 106 can also be connected to an imaging interface 1722 adapted to connect the system to an imaging device 1724. In one embodiment, the frames of input video on which the anomaly detector is run are received from the imaging device. The imaging device 1724 can include a video camera, computer, mobile device, webcam, or any combination thereof.

In some embodiments, the system 106 is connected to an application interface 1726 through the bus 1704 adapted to connect the system 106 to an application device 1728 that can operate based on the results of anomaly detection. For example, device 1728 is a surveillance system that uses the locations of detected anomalies to alert a security guard to investigate further.

A network interface controller 1730 is adapted to connect the system 106 through the bus 1704 to a network 1732. Through network 1732, the video frames 1734, e.g., frames of the normal or training video 402 and/or input or testing video 104 can be downloaded and stored within the computer's storage system 1708 for storage and/or further processing. In some embodiments, features computed from the training and input frames of videos are stored instead of the original frames. In such a manner, the storage requirements can be reduced, while improving subsequent processing of the videos.

Some embodiments are based on recognizing that video anomaly detection can be approached by comparing feature vectors that capture both the appearance and motion information of objects in training video to the same types of feature vectors computed from input video. However, storing and comparing all possible feature vectors from the training video is not computationally feasible.

It is an object of some embodiments to address this limitation by selecting a set of representative feature vectors from the training video, called exemplars, that cover the set of all possible feature vectors from the training video. Exemplars can be selected from the full set of training feature vectors using various algorithms such as clustering algorithms or exemplar-selection algorithms. The resulting set of exemplar feature vectors has the property that there is a minimum distance between any two exemplars.

Various exemplar selection algorithms compute a distance between two feature vectors. In some embodiments, a feature vector includes multiple component features for appearance, size, location, and trajectory. Let feature vector f₁=[a₁, s₁, l₁, t₁] where a₁=[a₁₁, a₁₂, . . . , a₁ₙ] is an appearance feature vector of length n, s₁=[w₁, h₁] is the size feature vector representing the width and height of an object bounding box, l₁=[x₁, y₁] is the location feature vector representing the (x,y) image coordinates of the center of an object bounding box and t₁=[dx₁₁, dy₁₁, dx₁₂, dy₁₂ . . . , dx_{1F}, dy_{1F}] is the trajectory feature vector representing the x and y displacements (dx₁ᵢ, dy₁ᵢ) of the center of the object bounding box for F consecutive video frames.

### Different Embodiments can Use Diverse Types of Distance Formulations.

The system 106 may thus be used in numerous anomaly detection applications.

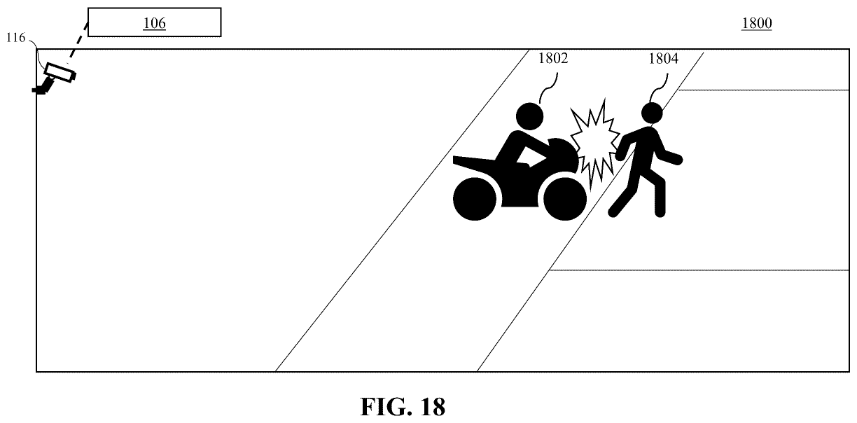

FIG. 18 illustrates a schematic diagram of an application of the system 106 in a real world environment 1800 for anomaly detection, according to an embodiment of the present disclosure. The real world environment 1800 corresponds to the scene 102 where a person 1804 is loitering on the sidewalk in front of the crosswalk and then a person riding a bike 1802 nearly runs into him. The person 1804 moves out of the way and the biker 1802 continues across the street. The camera 116, which may be a CCTV camera installed on the street, captures this scene as the input video and transmits this video to the system 106. The system 106 detects a good proportion of the anomalous activity as anomalous. The system 106 also detects the person loitering 1804 as anomalous based on context of interaction of the person 1802 and the person 1804 which are detected as objects in the scene 102 of the real-world environment 1800.

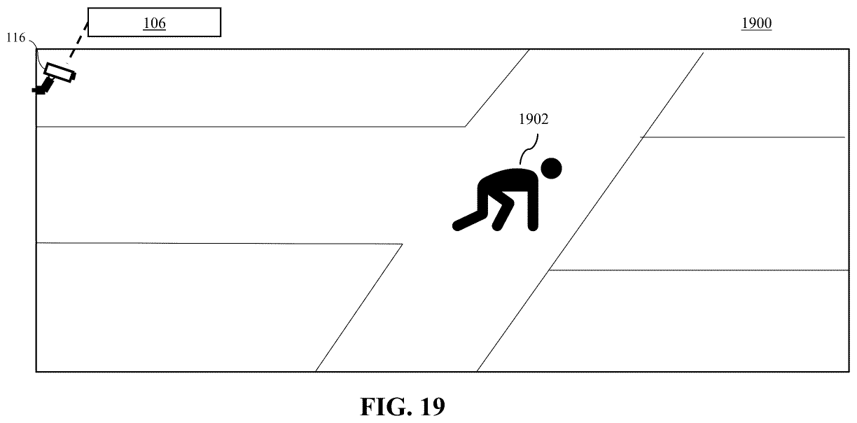

FIG. 19 illustrates a schematic diagram of another application of the system 106 in a real world environment 1900 for anomaly detection, according to an embodiment of the present disclosure. The real world environment 1900 corresponds to the scene 102 where a person 1902 a person is crossing the street at the crosswalk and then suddenly kneels down in the middle of the street. The person 1902 then gets back up and continues walking. The camera 116, which may be a CCTV camera installed on the street, captures this scene as the input video and transmits this video to the system 106. The scene-graph method does a decent job of detecting this anomalous activity both temporally and spatially with no false positives.

Thus, the system 106 is able to accurately detect anomalies in a variety of real-world applications based on modeling of interactions among the objects in the form of context features and comparing these interactions to interactions of objects in normal scenarios captured in normal videos of different application scenes in the form of exemplars. Therefore, the system 106 provides a technical advantage of being computationally less intensive by the use of pre-stored exemplar data for detecting anomalies, while at the same time providing a technical solution of more accurate anomaly detection to the technical problem of detecting anomalies in videos captured by cameras, and in surveillance applications.

The above-described embodiments of the present disclosure can be implemented in numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish the claim elements.

Although the disclosure has been described by way of examples of preferred embodiments, it is to be understood that various other adaptations and modifications can be made within the spirit and scope of the disclosure.

Therefore, it is the object of the appended claims to cover all such variations and modifications as coming within the true spirit and scope of the disclosure.

Claimed is:

1. A system for video anomaly detection in a scene, comprising:
an input interface configured to accept an input video of the scene;
a memory configured to store a set of exemplars, each exemplar in the set of exemplars includes features that are extracted from tracked bounding boxes of an object tracked in different frames of a normal video of the scene, and combined with features representing a context associated with the object in the normal video of the scene, the features representing the context are extracted from bounding boxes in proximity of the tracked bounding boxes;
a processor configured to
track an object moving in the input video of the scene by detecting bounding boxes of the object in a set of frames of the input video;
extract combined features of the object in the scene from the detected bounding boxes, the combined features indicative of at least:
an appearance of the object in the scene, a size of the object in the scene, a location of the object in the scene, and a trajectory of the object within the scene;
extract context features from a set of frames of the input video in proximity of the detected bounding boxes, the context features indicative of context of the object in the scene;
generate an input feature vector for the object by combining the combined features with the context features;
determine a smallest distance from the input feature vector to a corresponding closest exemplar based on a comparison of the input feature vector with each exemplar in the set of exemplars; and
output an anomaly detection result based on a comparison of the smallest distance with a threshold, wherein the anomaly detection result is indicative of a presence of an anomaly or an absence of the anomaly, for performing the video anomaly detection in the scene.

2. The system of claim 1, wherein the context of the object in the scene is indicative of an interaction of the object with one or more other objects in the scene, such that the one or more other objects occur in the set of frames of the input video in proximity of the detected bounding boxes.

3. The system of claim 1, wherein the scene includes a first object and a second object, and wherein the context features of the first object are the combined features of the second object, such that the object is either of the first object or the second object.

4. The system of claim 1, wherein the processor is configured to:
extract trajectory features of the object in the scene based on the tracking of the object such that the trajectory features are indicative of the trajectory of the object in the scene, the trajectory including data associated with a displacement of the object from one frame to the next across multiple consecutive frames of the set of frames of the input video, wherein the combined features include the trajectory features.

5. The system of claim 4, wherein the processor is configured to:
detect the object in an input frame of the input video from the set of input frames of the input video to place a bounding box enclosing the object;
track the object in other input frames from the set of input frames to place bounding boxes enclosing the object in multiple input frames;
extract appearance features from the bounding box enclosing the object in the input frame, the appearance features indicative of the appearance of the object in the scene, the size of the object in the scene, and the location of the object in the scene; and
extract the trajectory features from the bounding boxes enclosing the object in multiple input frames.

6. The system of claim 5, wherein the processor is configured to detect the object and determine the trajectory of the object by executing one or multiple neural networks trained with machine learning.

7. The system of claim 5, wherein, to extract the trajectory features from the bounding boxes enclosing the object in the multiple input frames, the processor is configured to:
determine coordinates of pixels at the center of each of the bounding boxes to form a sequence of coordinates; and
form the trajectory features as horizontal and vertical displacements of the coordinates from one frame to a next frame in the sequence of coordinates.

8. The system of claim 1, wherein, to extract the combined features from the detected bounding boxes, the processor is configured to:
extract features of each of the bounding boxes enclosing the object in each frame of the set of frames, with a deep neural network trained to classify the object; and
form the combined features as an output of an internal layer of the deep neural network.

9. The system of claim 1, wherein to determine the smallest distance from the input feature vector to the corresponding closest exemplar, the processor is configured to:
determine distance values of the input feature vector from each exemplar in the set of exemplars;
determine a smallest distance value from the determined distance values; and
output an exemplar corresponding to the smallest distance value as the closest exemplar having the smallest distance from the input feature vector.

10. The system of claim 9, wherein the processor is configured to:
determine an anomaly score for the input feature vector based on the smallest distance value; and
output the anomaly detection result based on the comparison of the anomaly score with the threshold, such that when the smallest distance is greater than the threshold, the anomaly detection result is indicative of the presence of the anomaly in the scene and when the smallest distance is lesser than the threshold, the anomaly detection result is indicative of the absence of the anomaly in the scene.

11. The system of claim 1, wherein the processor is configured to:
select the set of exemplars based on feature vectors computed from objects found in the normal video of the scene, the selection comprising:
initializing the set of exemplars to a null value;
adding a first element to the set of exemplars wherein the first element is a feature vector computed from the normal video of the scene; and
update the set of exemplars to add a subsequent element based on a distance of a candidate subsequent element from a nearest instance in the set of exemplars.

12. The system of claim 1, wherein the processor is configured to:
transform the input feature vector to a scene graph, wherein the scene graph comprises a spatio-temporal scene graph corresponding to the scene, such that the spatio-temporal scene graph includes nodes representing one or multiple static objects in the scene and one or multiple dynamic objects in the scene;
determine a pair of connected nodes from the nodes of the scene graph, wherein the pair of connected nodes are associated with the appearance features and the context features; and
determine a distance value for each pair of connected nodes in the scene graph and each pair of exemplar nodes in the set of exemplars; and
output the anomaly detection result based on the comparison of the distance value with the threshold.

13. The system of claim 12, wherein the scene graph further comprises a set of isolated nodes.

14. The system of claim 12, wherein each of the nodes of the scene graph comprises a high-level representation of the object, the high-level representation comprising a set of attributes, the set of attributes further comprising: a bounding box size, a class identifier, a location, a trajectory vector, and a pose vector.

15. The system of claim 14, wherein a distance between any two nodes of the scene graph is a combination of distances between the set of the attributes corresponding to each of the nodes, wherein each of the two nodes is one of the nodes of the scene graph.

16. A system for video anomaly detection in a scene, comprising:
an input interface configured to accept an input video of the scene;
a memory configured to store a set of exemplars, each exemplar in the set of exemplars includes features that are extracted from tracked bounding boxes of a first object tracked in different frames of a normal video of the scene and combined with features of a second object tracked in the different frames of the normal video of the scene, such that the second object is in proximity of the tracked bounding boxes of the first object;
a processor configured to
track the first object moving in the input video of the scene by detecting bounding boxes of the first object in a set of frames of the input video;
extract combined features of the first object in the scene from the detected bounding boxes, the combined features indicative of at least: an appearance of the first object in the scene, a size of the first object in the scene, a location of the first object in the scene, and a trajectory of the first object within the scene;
extract context features of the second object in the scene, from the set of frames of the input video in proximity of the bounding boxes of the first object, the context features of the second object indicative of an appearance of the second object in the scene, a size of the second object in the scene, a location of the second object in the scene, and a trajectory of the second object within the scene;
generate an input feature vector by combining the combined features of the first object and the context features of the second object;
determine a smallest distance from the input feature vector to its closest exemplar based on a comparison of the input feature vector with each exemplar in the set of exemplars; and
output an anomaly detection result based on a comparison of the smallest distance with a threshold, wherein the anomaly detection result is indicative of a presence of an anomaly or an absence of the anomaly, for performing the video anomaly detection in the scene.

17. A method for video anomaly detection in a scene, comprising:
accepting an input video of the scene;
tracking an object moving in the input video of the scene by detecting bounding boxes of the object in a set of frames of the input video;
extracting combined features of the object in the scene from the detected bounding boxes, the combined features indicative of at least: an appearance of the object in the scene, a size of the object in the scene, a location of the object in the scene, and a trajectory of the object within the scene;
extracting context features from the set of frames of the input video in proximity of the detected bounding boxes, the context features indicative of context of the object in the scene;
generating an input feature vector for the object by combining the combined features with the context features;
determining a smallest distance from the input feature vector to a corresponding closest exemplar based on a comparison of the input feature vector with each exemplar in a set of exemplars, wherein the each exemplar includes features that are extracted from tracked bounding boxes of an object tracked in different frames of a normal video of the scene and combined with features representing a context associated with the object, the features representing the context are extracted from bounding boxes in proximity of the tracked bounding boxes; and
outputting an anomaly detection result based on a comparison of the smallest distance with a threshold, wherein the anomaly detection result is indicative of a presence of an anomaly or an absence of the anomaly in the scene.

18. The method of claim 17, wherein the context associated with the object in the scene is indicative of an interaction of the object with one or more other objects in the scene, such that the one or more other objects correspond to the set of frames of the input video in proximity of the detected bounding boxes.

19. The method of claim 17, wherein the scene includes a first object and a second object, and wherein the combined features of the first object are the appearance features of the second object, such that the object is either of the first object or the second object.

20. The method of claim 17, further comprising:
extracting trajectory features of the object in the scene based on the tracking of the object such that the trajectory features are indicative of the trajectory of the object in the scene, the trajectory including data associated with a displacement of the object from one frame to the next across multiple consecutive frames of the set of frames of the input video, wherein the combined features include the trajectory features.
